(19) United States
(12) Patent Application Publication
(10) Pub. No.: US 2011/0249181 A1
(43) Pub. Date: Oct. 13, 2011

(54) TRANSMITTING DEVICE, RECEIVING DEVICE, CONTROL METHOD, AND COMMUNICATION SYSTEM

(75) Inventors: HIDEKI IWAMI, SAITAMA (JP); OSAMU YOSHIMURA, KANAGAWA (JP); CHIHIRO FUJITA, KANAGAWA (JP); SATOSHI TSUBAKI, KANAGAWA (JP); YOSHINOBU KURE, KANAGAWA (JP)

(73) Assignee: SONY CORPORATION, TOKYO (JP)

(21) Appl. No.: 13/079,200

(22) Filed: Apr. 4, 2011

(30) Foreign Application Priority Data
Apr. 9, 2010 (JP) 2010-090962

(51) Int. Cl. H04N 5/04; H04N 5/38; H04N 7/26

(52) U.S. Cl. 348/501; 375/240.26; 375/240.27; 348/723; 348/E05.009; 348/E05.093; 375/E07.2

(57) ABSTRACT

Disclosed herein is a transmitting device, including: a reproduction time information adding portion configured to add reproduction time information specifying timing of reproduction of data as an object of transmission to the data; a control time information adding portion configured to add control time information specifying control timing when circuit control is performed on a circuit, the data being to be transmitted through the circuit, to data transfer control information; and a transmitting portion configured to transmit data to which the reproduction time information and the control time information are added.

### BACKGROUND OF THE INVENTION

1. Field of the Invention

The present invention relates to a transmitting device, a receiving device, a control method, and a communication system, and particularly to a transmitting device, a receiving device, a control method, and a communication system that make it possible to achieve high-precision synchronization.

2. Description of the Related Art

Applications and services for transferring image data (moving image data in particular) via various networks such as the Internet, a LAN (Local Area Network) and the like are now in wide use. When image data is transmitted and received via a network, it is common to send out the image data after reducing the amount of the data by coding (compression) processing on a transmitting side, and subject the coded data received to decoding (decompression) processing and reproduce the data on a receiving side.

There is for example compression technology referred to as MPEG (Moving Picture Experts Group) as a most widely known method of image compression processing. When the MPEG compression technology is used, an MPEG stream generated by the MPEG compression technology is stored in an IP packet in compliance with an IP (Internet Protocol), and distributed via a network. Then, the MPEG stream is received by using communication terminals such as a PC (Personal Computer), a PDA (Personal Digital Assistant), a portable telephone and the like, and is displayed on the screen of each terminal.

In such a situation, there is an environment in which not all data on a transmitting side reaches a receiving side due to the jitter of a network, and there is an environment in which image data is received by terminals having different capabilities, in applications intended mainly to distribute image data, such for example as video on demand, distribution of live video, videoconferencing, videophones and the like, and these environments need to be assumed.

For example, image data transmitted from one transmission source may be received and displayed by a receiving terminal having a display with a low resolution and a CPU having low processing power, such as a portable telephone or the like. In addition, at the same time, the image data may be received and displayed by a receiving terminal having a monitor with a high resolution and a processor of high performance, such as a desktop PC or the like.

When it is assumed that packet receiving conditions are different according to a network connection environment, technology referred to as hierarchical coding, which codes data to be transmitted and received hierarchically, for example, is used. In hierarchically coded image data, coded data for receiving terminals having a display with a high resolution and coded data for receiving terminals having a display with a low resolution, for example, are retained in a state of being separated from each other to allow image size and image quality to be changed as appropriate on a receiving side.

There are video streams provided by MPEG-4 and JPEG 2000, for example, as compression and decompression systems capable of hierarchical coding. In MPEG-4, FGS (Fine Granularity Scalability) technology is expected to be incorporated and profiled as a standard. This hierarchical coding technology is said to enable scalable distribution in a range from a low bit rate to a high bit rate. In addition, JPEG 2000 based on a wavelet transform can generate packets on the basis of spatial resolution utilizing features of the wavelet transform, or hierarchically generate packets on the basis of image quality. In addition, JPEG 2000 can store hierarchized data in a file format according to a Motion JPEG 2000 (Part 3) standard that can handle not only still images but also moving images.

Further, there is a system based on a discrete cosine transform (DCT) as a system proposed as a concrete scheme for data communication to which hierarchical coding is applied. This method subjects for example image data as an object for communication to DCT processing, achieves hierarchization by distinguishing high frequencies and low frequencies from each other by the DCT processing, generates packets divided into layers of high frequencies and low frequencies, and performs data communication.

When such hierarchically coded image data is distributed, a real-time characteristic is required in many cases. In a present situation, however, large-screen and high-image-quality display tends to take priority over the real-time characteristic.

In order to ensure the real-time characteristic in distribution of image data, a UDP (User Datagram Protocol) is generally used as an IP-based communication protocol. Further, an RTP (Real-time Transport Protocol) is used in a layer above the UDP. The data format of data stored in RTP packets conforms to an individual format defined for each application, that is, each coding system.

In addition, for a communication network, a communication system such as a wireless or wired LAN, optical fiber communication, xDSL, power line communication, Co-ax or the like is used. These communication systems have been increased in speed year after year, and image contents transmitted by the communication systems have also been increased in quality.

For example, a typical system in the MPEG system or the JPEG 2000 system, which is now mainstream, has a code delay (a coding delay+a decoding delay) of two pictures or more, which makes it difficult to say that a sufficient real-time characteristic in image data distribution is secured.

Accordingly, an image compression system for shortening a delay time by dividing one picture into sets of N lines (N is one or more) and coding each divided set (referred to as a line block) of the image (which system will hereinafter be referred to as a line-based codec) has recently started to be proposed. Advantages of the line-based codec include a low delay and an advantage of enabling high-speed processing and reduction in hardware scale because of a small amount of information handled in one unit of image compression.

Cases proposed for the line-based codec include the following examples. Japanese Patent Laid-Open No. 2007-311948 (as Patent Document 1) describes a communicating device that properly interpolates missing data in each line block for communication data based on the line-based codec. Japanese Patent Laid-Open No. 2008-28541 (as Patent Document 2) describes an information processing device that achieves a delay reduction and an improvement in efficiency of processing in a case where the line-based codec is used. Japanese Patent Laid-Open No. 2008-42222 (as Patent Document 3) describes a transmitting device for suppressing degradation in image quality by transmitting the low-frequency component of image data resulting from a line-based wavelet transform. Because high-image-quality and low-delay transmission can be made by using the line-based codec, the line-based codec is expected to be applied to camera systems that perform live relay broadcasting in the future. As is disclosed in Japanese Patent No. 3617087 (as Patent Document 4) as a case proposed for a camera system that performs live relay broadcasting, the present applicants have proposed a system for increasing transmission efficiency by using a digital modulator.

Accordingly, as is disclosed in Japanese Patent Laid-Open No. 2009-278545 (as Patent Document 5), the present applicant has developed techniques for obtaining synchronization stably in communications using the line-based codec.

### SUMMARY OF THE INVENTION

However, when a camera system that performs existing live relay broadcasting is to provide high image quality and be made compatible with a general-purpose circuit such as Ethernet (registered trademark), NGN (Next Generation Network), radio or the like, it is difficult to perform image switching processing, which is a core technique of live relay broadcasting, at high speed, due to an increase in amount of delay. For example, in the case of a broadcasting system, high precision is necessary to phase a plurality of cameras, and it is difficult to achieve high image quality and high-precision synchronization.

Further, provision needs to be made for the complexity of a camera system that performs live relay broadcasting. In a present situation, in a camera system that needs one CCU (Camera Control Unit) for cameras and which has a complex system configuration, it is difficult to add a live relay broadcasting control station having different frame synchronization timing from a viewpoint of connection and system synchronization. It is difficult to make provision for high-precision synchronization timing necessary for genlocking to a camera which genlocking is essential to a camera system that performs live relay broadcasting while satisfying requirements for high image quality and a low delay.

The present invention has been made in view of such a situation. It is desirable to be able to achieve high-precision synchronization.

According to a first embodiment of the present invention, there is provided a transmitting device including: reproduction time information adding means for adding reproduction time information specifying timing of reproduction of data as an object of transmission to the data; control time information adding means for adding control time information specifying control timing when circuit control is performed on a circuit, the data being to be transmitted through the circuit, to data transfer control information; and transmitting means for transmitting data to which the reproduction time information and the control time information are added.

According to the first embodiment of the present invention, there is provided a control method including the steps of: adding reproduction time information specifying timing of reproduction of data as an object of transmission to the data; adding control time information specifying control timing when circuit control is performed on a circuit, the data being to be transmitted through the circuit, to data transfer control information; and transmitting data to which the reproduction time information and the control time information are added.

In the first embodiment of the present invention, reproduction time information specifying timing of reproduction of data as an object of transmission is added to the data, control time information specifying control timing when circuit control is performed on a circuit, the data being to be transmitted through the circuit, is added to data transfer control information, and data to which the reproduction time information and the control time information are added is transmitted.

According to a second embodiment of the present invention, there is provided a receiving device including: receiving means for receiving transmitted data; synchronization processing means for extracting control time information specifying control timing when circuit control is performed on a circuit, the data having been transmitted through the circuit, from the data, and performing synchronization processing based on the control time information; and reproduction processing means for extracting reproduction time information specifying timing of reproduction of the data from the data, and performing reproduction processing in timing based on the reproduction time information.

According to the second embodiment of the present invention, there is provided a control method including the steps of: receiving transmitted data; extracting control time information specifying control timing when circuit control is performed on a circuit, the data having been transmitted through the circuit, from the data, and performing synchronization processing based on the control time information; and extracting reproduction time information specifying timing of reproduction of the data from the data, and performing reproduction processing in timing based on the reproduction time information.

In the second embodiment of the present invention, transmitted data is received, control time information specifying control timing when circuit control is performed on a circuit, the data having been transmitted through the circuit, is extracted from the data, and synchronization processing based on the control time information is performed. Then, reproduction time information specifying timing of reproduction of the data is extracted from the data, and reproduction processing is performed in timing based on the reproduction time information.

According to a third embodiment of the present invention, there is provided a communication system including: reproduction time information adding means for adding reproduction time information specifying timing of reproduction of data as an object of transmission to the data; control time information adding means for adding control time information specifying control timing when circuit control is performed on a circuit, the data being to be transmitted through the circuit, to data transfer control information; transmitting means for transmitting data to which the reproduction time information and the control time information are added; receiving means for receiving the transmitted data; synchronization processing means for extracting the control time information from the data, and performing synchronization processing based on the control time information; and reproduction processing means for extracting the reproduction time information from the data, and performing reproduction processing in timing based on the reproduction time information.

According to the third embodiment of the present invention, there is provided a control method including the steps of: adding reproduction time information specifying timing of reproduction of data as an object of transmission to the data; adding control time information specifying control timing when circuit control is performed on a circuit, the data being to be transmitted through the circuit, to data transfer control information; transmitting data to which the reproduction time information and the control time information are added; receiving the transmitted data; extracting the control time information from the data, and performing synchronization processing based on the control time information; and extracting the reproduction time information from the data, and performing reproduction processing in timing based on the reproduction time information.

In the third embodiment of the present invention, reproduction time information specifying timing of reproduction of data as an object of transmission is added to the data, control time information specifying control timing when circuit control is performed on a circuit, the data being to be transmitted through the circuit, is added to data transfer control information, and data to which the reproduction time information and the control time information are added is transmitted. On the other hand, the transmitted data is received, the control time information is extracted from the data, and synchronization processing based on the control time information is performed. Then, the reproduction time information is extracted from the data, and reproduction processing is performed in timing based on the reproduction time information.

According to the first to third embodiments of the present invention, high-precision synchronization can be achieved.

### BRIEF DESCRIPTION OF THE DRAWINGS

FIG. 1 is a diagram showing an example of configuration of a coding device for coding image data;

FIG. 2 is a diagram showing a constitution of coefficient data divided by repeating analysis filtering four times;

FIG. 3 is a diagram of assistance in explaining a line block;

FIG. 4 is a block diagram showing an example of configuration of a first embodiment of a communication system to which the present invention is applied;

FIG. 5 is a diagram of assistance in explaining transmission and reception of image data between a CCU and a camera;

FIG. 6 is a block diagram showing a configuration of a CCU;

FIG. 7 is a flowchart showing the flow of a process of transmitting image data in a camera;

FIG. 8 is a flowchart showing the flow of a process of receiving image data in a CCU;

FIG. 9 is a diagram of assistance in explaining the frame format of an IP packet;

FIG. 10 is a diagram of assistance in explaining a difference in synchronization between CCUs;

FIG. 11 is a diagram of assistance in explaining an outline of operation of a delay controlling device;

FIG. 12 is a block diagram showing an example of configuration of the delay controlling device;

FIG. 13 is a block diagram showing an example of configuration of a second embodiment of the communication system to which the present invention is applied;

FIG. 14 is a diagram showing system timing after synchronization is obtained;

FIG. 15 is a diagram of assistance in explaining a total amount of delay in the communication system;

FIG. 16 is a flowchart showing the flow of a delay controlling process;

FIG. 17 is a diagram of assistance in explaining a synchronizing method for video control layer synchronization;

FIG. 18 is a diagram of assistance in explaining the frame format of an IP packet as a first example of configuration;

FIG. 19 is a block diagram showing an example of configuration of an imaging display device to which the present invention is applied;

FIG. 20 is a diagram of assistance in explaining the frame format of an IP packet as a second example of configuration;

FIG. 21 is a diagram of assistance in explaining the frame format of an IP packet as a third example of configuration; and

FIG. 22 is a block diagram showing an example of configuration of an embodiment of a computer to which the present invention is applied.

### DETAILED DESCRIPTION OF THE PREFERRED EMBODIMENTS

Concrete embodiments to which the present invention is applied will hereinafter be described in detail with reference to the drawings.

### [Description of Coding Process]

A process of coding image data will first be described.

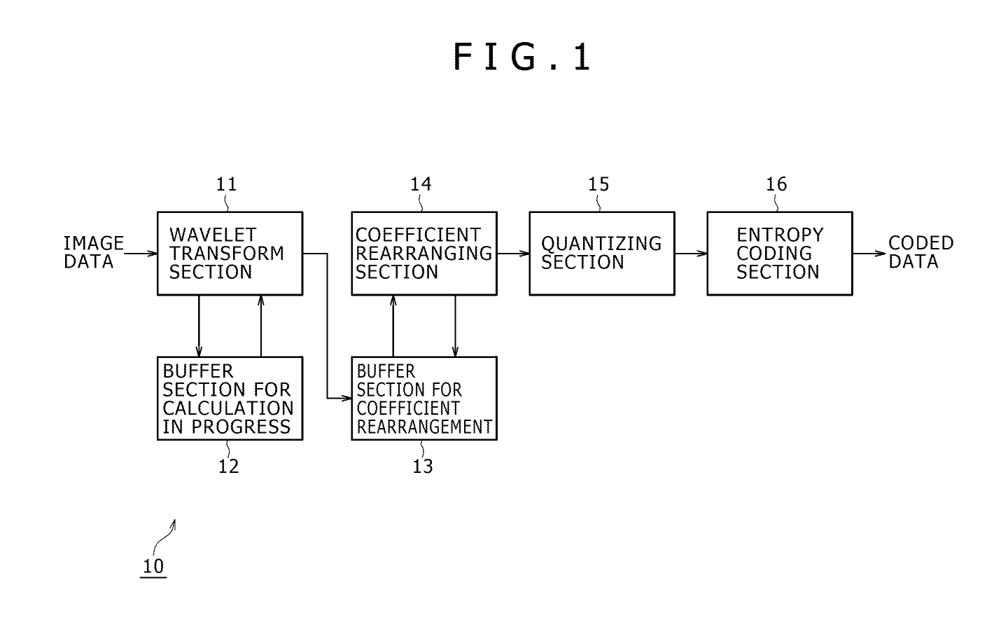

FIG. 1 is a diagram showing an example of configuration of a coding device for coding image data.

The coding device 10 shown in FIG. 1 generates coded data by coding image data input to the coding device 10, and outputs the coded data. As shown in FIG. 1, the coding device 10 includes a wavelet transform section 11, a buffer section 12 for calculation in progress, a buffer section 13 for coefficient rearrangement, a coefficient rearranging section 14, a quantizing section 15, and an entropy coding section 16.

The image data input to the coding device 10 is temporarily stored in the buffer section 12 for calculation in progress via the wavelet transform section 11.

The wavelet transform section 11 subjects the image data stored in the buffer section 12 for calculation in progress to a wavelet transform. Details of the wavelet transform will be described later. The wavelet transform section 11 supplies coefficient data obtained by the wavelet transform to the buffer section 13 for coefficient rearrangement.

The coefficient rearranging section 14 reads out the coefficient data written to the buffer section 13 for coefficient rearrangement in predetermined order (for example in order of wavelet inverse transform processing), and supplies the read coefficient data to the quantizing section 15.

The quantizing section 15 quantizes the coefficient data supplied to the quantizing section 15 by a predetermined method, and supplies resulting coefficient data (quantized coefficient data) to the entropy coding section 16.

The entropy coding section 16 codes the coefficient data supplied to the entropy coding section 16 by a predetermined entropy coding system such as Huffman coding or arithmetic coding, for example. The entropy coding section 16 outputs the generated coded data to the outside of the coding device 10.

### [Subbands]

A wavelet transform will next be described. The wavelet transform is a process of converting image data into coefficient data of each frequency component formed hierarchically by recursively repeating analysis filtering, which divides the image data into a component of high spatial frequency (high-frequency component) and a component of low spatial frequency (low-frequency component), on the generated low-frequency component. Incidentally, in the following, suppose that the layer of a high-frequency component is a lower division level, and that the layer of a low-frequency component is a higher division level.

In one layer (division level), analysis filtering is performed in both a horizontal direction and a vertical direction. The coefficient data (image data) of one layer is thereby divided into four kinds of components by analysis filtering for one layer. The four kinds of components are a component of high frequencies in both the horizontal direction and the vertical direction (HH), a component of high frequencies in the horizontal direction and low frequencies in the vertical direction (HL), a component of low frequencies in the horizontal direction and high frequencies in the vertical direction (LH), and a component of low frequencies in both the horizontal direction and the vertical direction (LL). The sets of the respective components will each be referred to as a subband.

In a state in which four subbands are generated by performing analysis filtering in a certain layer, analysis filtering for a next (immediately adjacent higher) layer is performed on a component of low frequencies in both the horizontal direction and the vertical direction (LL) among the four generated subbands.

The coefficient data of a low spatial frequency band is driven into a smaller region (low-frequency component) by thus repeating analysis filtering recursively. Thus, efficient coding can be performed by coding coefficient data thus resulting from a wavelet transform.

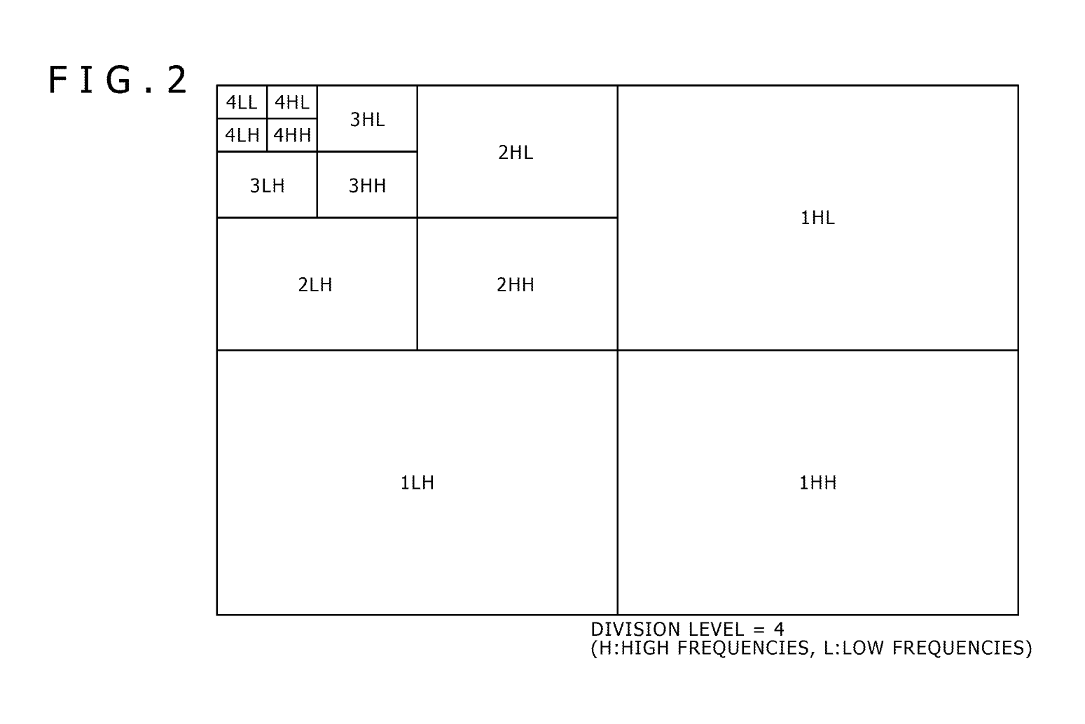

FIG. 2 shows a constitution of coefficient data divided into 13 subbands (1LH, 1HL, 1HH, 2LH, 2HL, 2HH, 3LH, 3HL, 3HH, 4LL, 4LH, 4HL, and 4HH) up to a division level 4 by repeating analysis filtering four times.

### [Line Block]

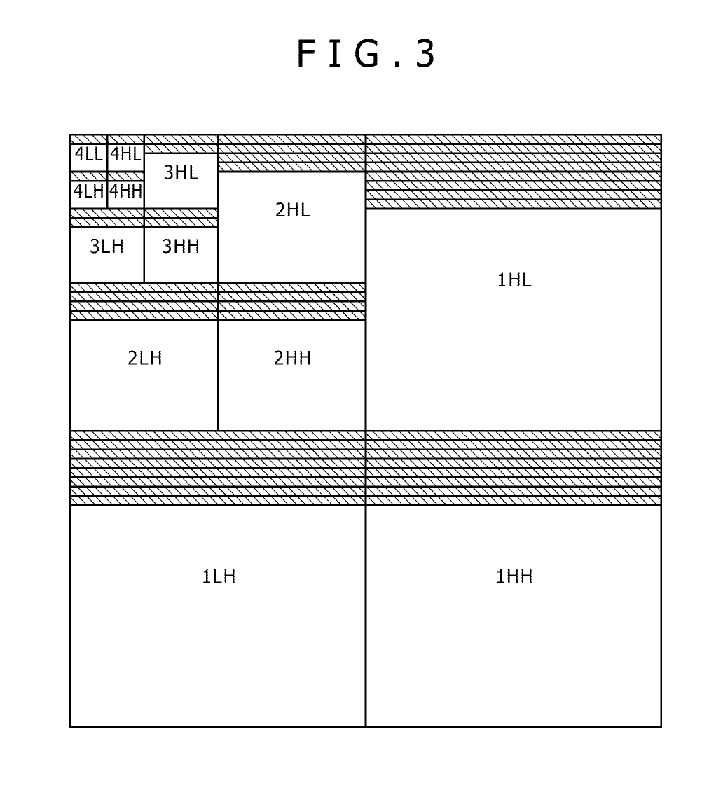

A line block will next be described. FIG. 3 is a diagram of assistance in explaining a line block. Analysis filtering in a wavelet transform generates, from two lines of image data or coefficient data as a processing object, one line of coefficient data of each of four subbands in a next higher layer.

Thus, for example, when the number of division levels is four, as indicated by hatched parts in FIG. 3, to generate one line of coefficient data of each of subbands at the division level 4 as the highest layer needs two lines of coefficient data of a subband 3LL.

To obtain the two lines of the subband 3LL, that is, to obtain two lines of coefficient data of each subband at the division level 3 needs four lines of coefficient data of a subband 2LL.

To obtain the four lines of the subband 2LL, that is, to obtain four lines of coefficient data of each subband at the division level 2 needs eight lines of coefficient data of a subband 1LL.

To obtain the eight lines of the subband 1LL, that is, to obtain eight lines of coefficient data of each subband at the division level 1 needs sixteen lines of coefficient data of a baseband.

That is, to obtain the one line of coefficient data of each subband at the division level 4 needs sixteen lines of image data of the baseband.

A number of lines of image data necessary to generate coefficient data for one line of a subband of the lowest-frequency component (4LL in the example of FIG. 3) will be referred to as a line block (or a precinct).

For example, when the number of division levels is M, to generate coefficient data for one line of a subband of a lowest-frequency component needs a number of lines of baseband image data which number is the Mth power of two. This is the number of lines of a line block.

Incidentally, a line block also refers to a set of coefficient data of each subband obtained by performing a wavelet transform of image data of the one line block.

In addition, a line represents a pixel row in the horizontal direction for one row of a frame image (picture) and a coefficient row in the horizontal direction for one row of a subband. This coefficient data for one line will be referred to also as a coefficient line. The image data for one line will be referred to also as an image line. The expressions will be changed in the following as appropriate when description needs to be made with a more detailed distinction.

In addition, coded data for one line which data is obtained by coding one coefficient line (coefficient data for one line) will be referred to also as a code line.

According to such a line-based wavelet transform process, as with the tile division of JPEG 2000, the process can be performed with one picture resolved into finer granularity, and a delay at times of transmission and reception of image data can be reduced. Further, unlike the tile division of JPEG 2000, the line-based wavelet transform performs division in wavelet coefficients rather than division of one baseband signal, and thus has another characteristic of preventing image degradation such as block noise at tile boundaries.

The description thus far has been made of a line-based wavelet transform as an example of a line-based codec. It is to be noted that each embodiment of the present invention to be described in the following is applicable not only to the line-based wavelet transform but also to an arbitrary line-based codec including existing hierarchical coding such as JPEG 2000 or MPEG-4, for example.

### First Embodiment

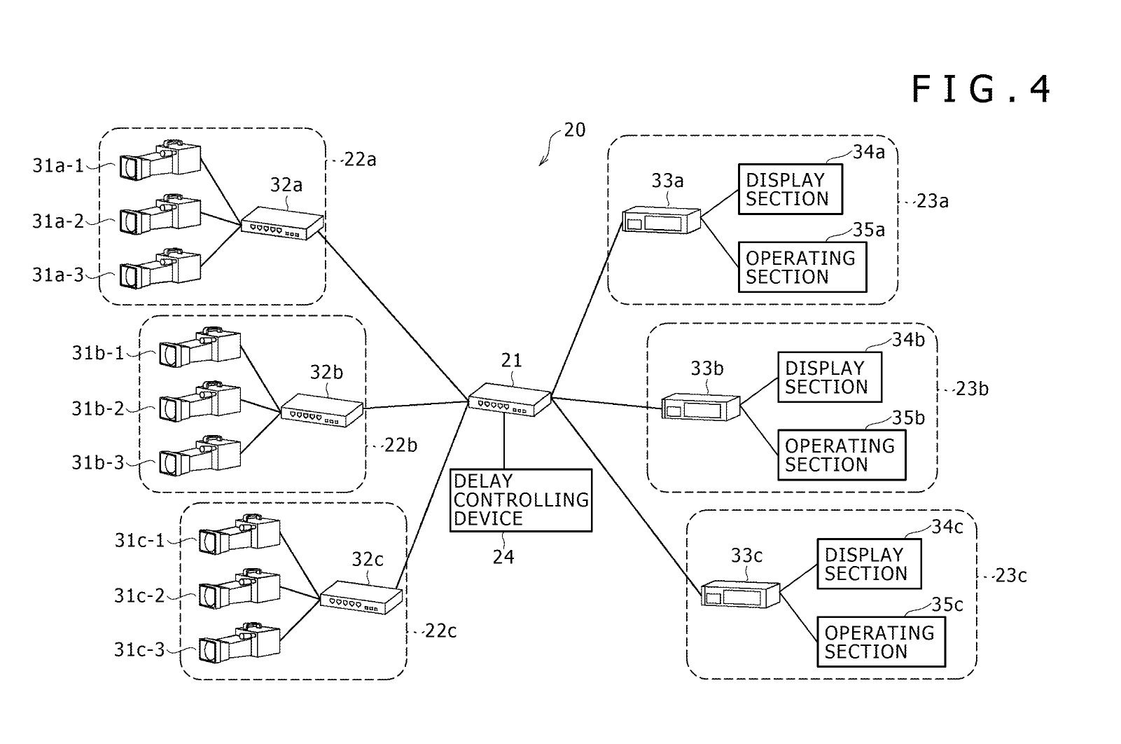

FIG. 4 is a block diagram showing an example of configuration of a first embodiment of a communication system to which the present invention is applied.

In FIG. 4, the communication system 20 includes a circuit switching device 21, three studios 22a to 22c, three subs 23a to 23c, and a delay controlling device 24. For example, in the communication system 20, devices are connected to each other by a general-purpose circuit such as Ethernet (registered trademark), NGN, radio or the like.

The circuit switching device 21 relays communications of the plurality of devices constituting the communication system 20, and is for example a hub in the case of Ethernet (registered trademark). Incidentally, a hub will be defined as a generic name for a line concentrator used in a star network, and may or may not have an SNMP (Simple Network Management Protocol) agent function. That is, the circuit switching device 21 is connected with the studios 22a to 22c, the subs 23a to 23c, and the delay controlling device 24 constituting the communication system 20, and mutual communications between the studios 22a to 22c, the subs 23a to 23c, and the delay controlling device 24 are performed via the circuit switching device 21.

The studios 22a to 22c are places for performing image pickup to generate image data. The studios 22a to 22c each have a plurality of cameras and a circuit switching device.

The studio 22a has cameras 31a-1 to 31a-3 and a circuit switching device 32a. The cameras 31a-1 to 31a-3 are connected to the circuit switching device 32a. The circuit switching device 32a is connected to the circuit switching device 21. As with the studio 22a, the studio 22b has cameras 31b-1 to 31b-3 and a circuit switching device 32b, and the studio 22c has cameras 31c-1 to 31c-3 and a circuit switching device 32c.

The subs 23a to 23c are places for selecting the studios 22a to 22c, controlling the cameras 31a-1 to 31c-3 provided to the studios 22a to 22c, respectively, and relaying image data. Incidentally, an environment in which the subs 23a to 23c are not synchronized with each other due to relation between devices of the respective subs 23a to 23c is assumed in the present embodiment.

The sub 23a has a CCU (Camera Control Unit) 33a, a display section 34a, and an operating section 35a. The display section 34a and the operating section 35a are connected to the CCU 33a. The CCU 33a is connected to the circuit switching device 21. The display section 34a is formed by an LCD (Liquid Crystal Display) or a CRT (Cathode Ray Tube), for example. The display section 34a displays images being picked up by the cameras 31a-1 to 31c-3 and the like. The operating section 35a is composed of a plurality of switches and levers. The operating section 35a for example allows a user to perform operations of selecting the studios 22a to 22c or the cameras 31a-1 to 31c-3 and changing an image.

As with the sub 23a, the sub 23b has a CCU 33b, a display section 34b, and an operating section 35b, and the sub 23c has a CCU 33c, a display section 34c, and an operating section 35c.

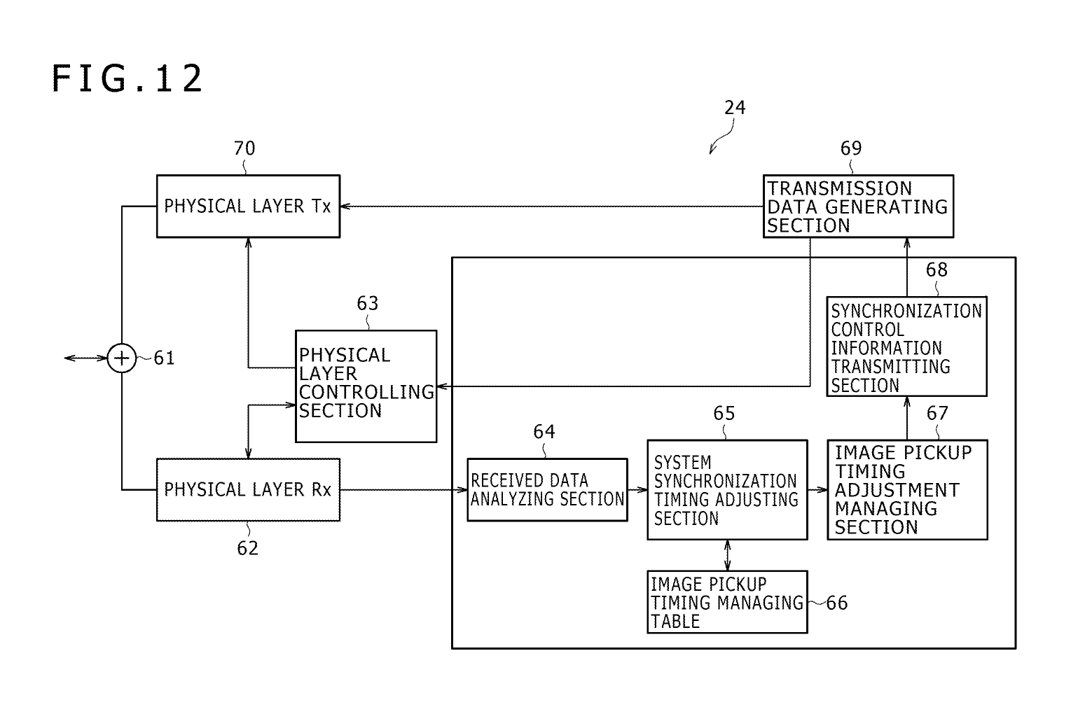

The delay controlling device 24 performs arbitration between the subs 23a to 23c, and determines master timing. Incidentally, a configuration of the delay controlling device 24 will be described later with reference to FIG. 12.

In the thus configured communication system 20, when synchronization is to be achieved between the camera 31a-1 of the studio 22a and the CCU 33a of the sub 23a, for example, a start of a picture is recognized, and thereafter decoding of each line (or each line block) within the picture is started from a predetermined decoding start point. That is, the line (or line block) decoding start point depends on a time when a transmission process on a transmitting side (camera 31a-1 side) is started. At this time, no problem is presented when the transmitting device and the receiving device are configured in a one-to-one relation to each other. However, in a case in which there are a plurality of transmitting devices for the receiving device (CCU 33a), a situation may occur in which synchronization is not achieved between a plurality of pieces of image data when the plurality of pieces of image data are managed or integrated on the receiving side. The present applicants have proposed a method for solving such a situation in which synchronization is not achieved between pieces of image data in the above-described Patent Document 5.

In addition to such a proposition, the invention of the present application proposes a method for enabling synchronization between pieces of image data to be achieved in all sets (combinations of cameras and CCUs) even in an environment in which a plurality of subs are not synchronized with each other due to relation between devices present within the respective subs.

A process of communication performed between each camera and each CCU in the communication system 20 will first be described by taking two cameras 31a-1 and 31a-2 and one CCU 33a as an example.

The cameras 31a-1 and 31a-2 are each a transmitting device for photographing a subject, generating a series of image data, and transmitting the series of image data to the CCU 33a. While FIG. 4 shows video cameras as an example of the cameras 31a-1 and 31a-2, the cameras 31a-1 and 31a-2 are not limited to video cameras. For example, the cameras 31a-1 and 31a-2 may be a digital still camera having a moving image photographing function, a PC, a portable telephone, a game machine or the like.

The CCU 33a is a device functioning as a master that determines timing of transmission and reception of image data in the communication system 20. While FIG. 4 shows a video processing device for business use as an example of the CCU 33a, the CCU 33a is not limited to a video processing device for business use. For example, the CCU 33a may be a personal computer, a video processing device for home use such as a video recorder or the like, a communicating device, an arbitrary information processing device or the like.

Incidentally, while the CCU 33a and the cameras 31a-1 and 31a-2 are connected to each other by wire communication via the circuit switching device 21 in FIG. 4, the CCU 33a and the cameras 31a-1 and 31a-2 may be connected to each other by radio communication based on standard specifications such as IEEE 802.11a, b, g, n, and s, for example.

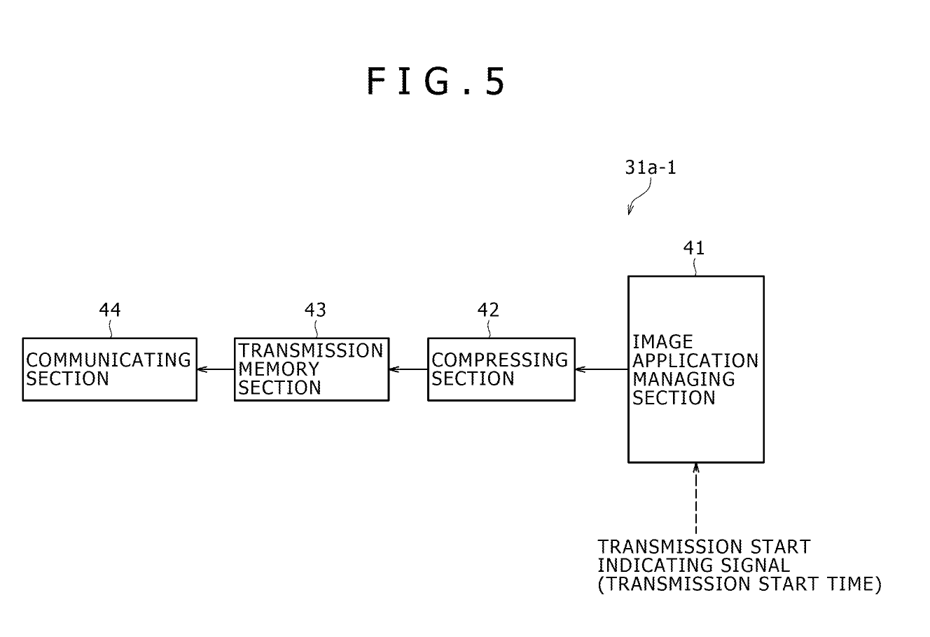

Transmission and reception of image data between the CCU 33a and the camera 31a-1 will next be described with reference to FIGS. 5 to 8. Incidentally, transmission and reception of image data between the CCU 33a and the camera 31a-2 are performed in a similar manner to that described in the following.

FIG. 5 is a block diagram showing a configuration of the camera 31a-1. As shown in FIG. 5, the camera 31a-1 includes an image application managing section 41, a compressing section 42, a transmission memory section 43, and a communicating section 44.

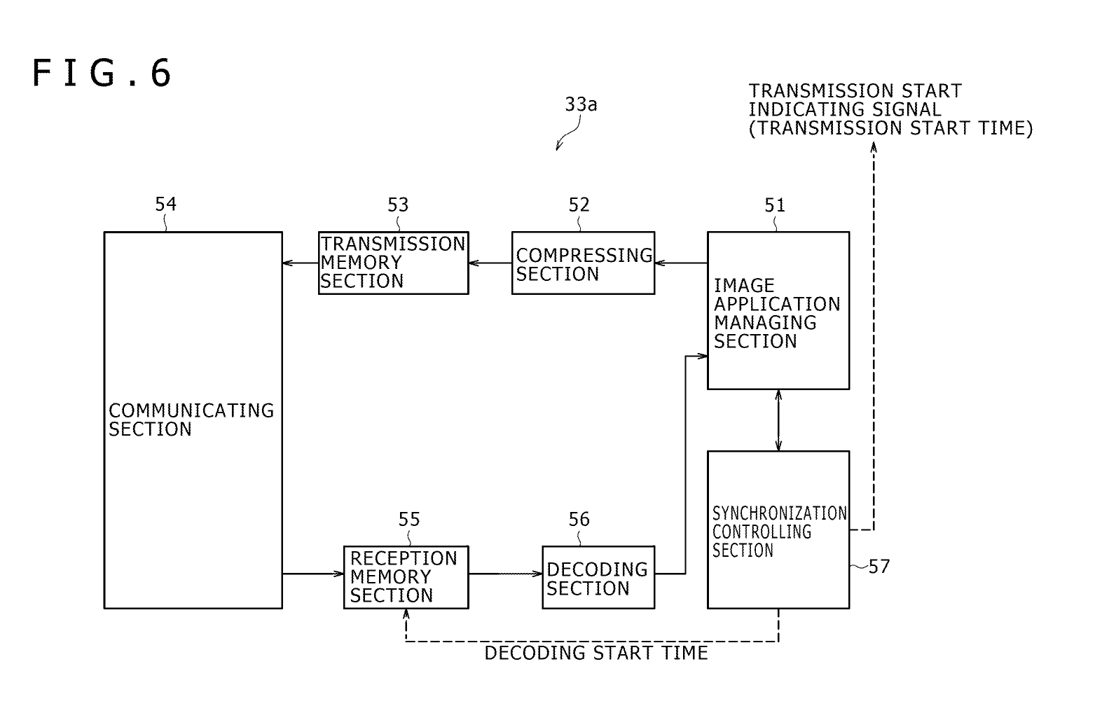

The image application managing section 41 receives a request to transmit image data picked up by an image input device (a CCD (Charge Coupled Device) or CMOS (Complementary Metal Oxide Semiconductor) sensor or the like) included in the camera 31a-1 from an application, performs route control and control relating to a wireless circuit according to QoS, and adjusts timing of transmission of image data between the camera 31a-1 and the CCU 33a. More specifically, the image application managing section 41 receives a transmission start indicating signal from a synchronization controlling section 57 (FIG. 6) of the CCU 33a to be described later, and outputs image data to the compressing section 42 at a specified transmission state time. Processes in the image application managing section 41 may also include control of the image input device.

The compressing section 42, the transmission memory section 43, and the communicating section 44 perform a process of transmitting a series of image data supplied from the image application managing section 41 in coding units described in connection with the present embodiment at the transmission start time.

FIG. 6 is a block diagram showing a configuration of the CCU 33a. Referring to FIG. 6, the CCU 33a includes an image application managing section 51, a compressing section 52, a transmission memory section 53, a communicating section 54, a reception memory section 55, a decoding section 56, and a synchronization controlling section 57.

The image application managing section 51 receives a request to transmit photographed image data from an application, and performs route control and control relating to a wireless circuit according to QoS or management of input and output of image data between the image application managing section 51 and the application.

The compressing section 52 reduces an amount of data by coding image data supplied from the image application managing section 51 in coding units of N lines (N is one or more) within a field according to the above-described line-based codec. The compressing section 52 thereafter outputs the data to the transmission memory section 53.

The transmission memory section 53 temporarily stores the data received from the compressing section 52. The transmission memory section 53 may also have a routing function for managing routing information according to a network environment and controlling data transfer to another terminal. Incidentally, the reception memory section 55 and the transmission memory section 53 may be integrated with each other to store transmission data and received data.

The communicating section 54 performs for example a process of receiving a series of image data in the above-described coding units which image data is transmitted from the communicating section 44 of the camera 31a-1 and a process of transmitting the transmission data stored in the transmission memory section 53.

For example, the communicating section 54 reads out the data stored in the transmission memory section 53, generates transmission packets (for example IP packets in a case of performing communication based on an IP protocol), and transmits the transmission packets. In addition, for example, when the communicating section 54 has received a communication packet, the communicating section 54 analyzes the received packet, separates image data and control data to be transferred to the image application managing section 51, and outputs the image data and the control data to the reception memory section 55. For example, in the case of performing communication based on the IP protocol, the communicating section 54 can refer to a destination IP address and a destination port number included in a received packet, and output image data and the like to the reception memory section 55. Incidentally, the communicating section 54 may have a routing function for controlling data transfer to another terminal.

The reception memory section 55 temporarily stores the data output from the communicating section 54, determines a time point at which to start decoding, and outputs data to be decoded to the decoding section 56. For example, the reception memory section 55 sets a decoding start time obtained from the synchronization controlling section 57 as the time point at which to start decoding the image data.

The decoding section 56 decodes the data output from the reception memory section 55 in units of N lines (N is one or more) within a field, and then outputs the decoded data to the image application managing section 51.

The synchronization controlling section 57 functions as a timing controller that controls timing of transmission and reception of image data between devices within the communication system 20. As with the image application managing section 51, the synchronization controlling section 57 is typically implemented as a process in an application layer.

The adjustment of timing of transmission and reception of image data by the synchronization controlling section 57 is started with the reception of an instruction from the image application managing section 51 or a synchronization request signal from the camera 31a-1, for example, as a trigger. Then, the synchronization controlling section 57 transmits a transmission start indicating signal specifying an image data transmission start time to the camera 31a-1, and specifies a decoding start time for the reception memory section 55.

Suppose that the image data transmission start time transmitted to the camera 31a-1 at this time is a time obtained by subtracting a time to accommodate a delay caused by variation in amount of data in each decoding unit or variation in a communication environment such as jitter in a communication path or the like, a hardware delay, a memory delay, or the like from the decoding start time specified for the reception memory section 55.

Incidentally, while the transmission start indicating signal is shown exchanged directly between the image application managing section 41 and the synchronization controlling section 57 in FIG. 5 and FIG. 6 to facilitate understanding of the description, the transmission start indicating signal is actually transmitted and received via the communicating sections 44 and 54.

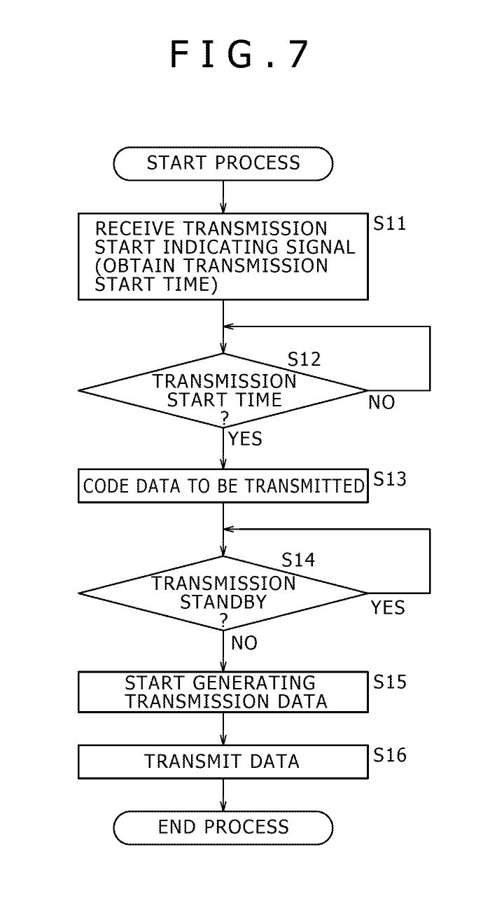

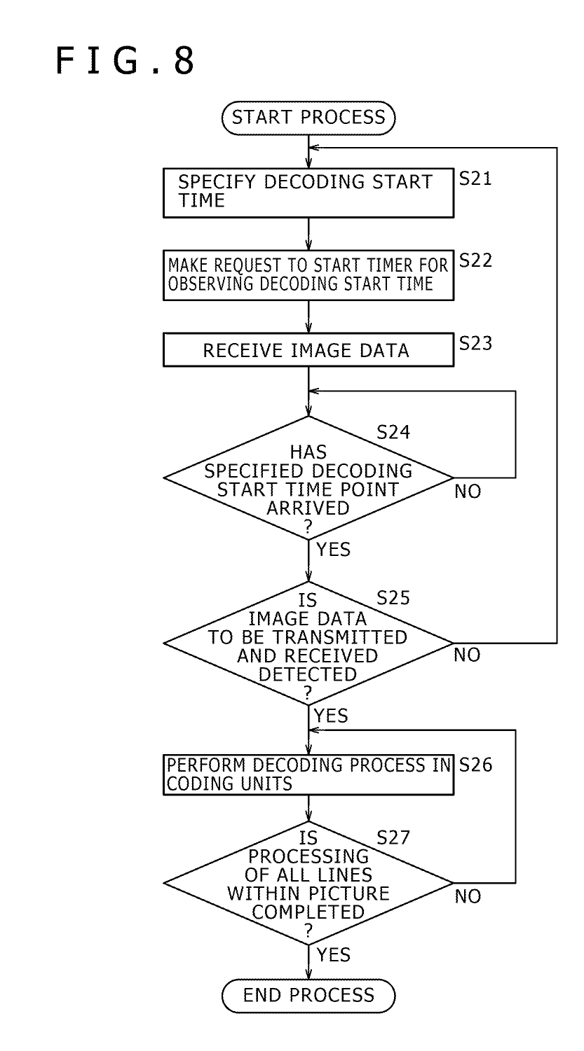

Flows of a process of transmitting image data by the camera 31a-1 and a process of receiving the image data by the CCU 33a will next be described with reference to FIG. 7 and FIG. 8.

FIG. 7 is a flowchart showing the flow of the process of transmitting image data in the camera 31a-1.

Referring to FIG. 7, first, the transmission start indicating signal transmitted from the CCU 33a is received by the image application managing section 41 (step S11). The image application managing section 41 obtains a transmission start time included in the transmission start indicating signal.

Then, the image application managing section 41 stands by until arrival of the transmission start time (step S12), and outputs image data to the compressing section 42 when the transmission start time has arrived. The compressing section 42 codes the output image data in coding units of N lines (N is one or more) within a field, and outputs the coded image data to the transmission memory section 43 (step S13). Thereafter, the image data is stored in the transmission memory section 43 according to a communication path and the progress of the transmitting process (step S14).

Thereafter, when transmission timing arrives, the image data is output from the transmission memory section 43 to the communicating section 44, and the generation of communication data including the image data is started (step S15). The communication data is then transmitted to the CCU 33a (step S16).

FIG. 8 is a flowchart showing the flow of the process of receiving the image data in the CCU 33a.

Referring to FIG. 8, first, the decoding start time is specified from the synchronization controlling section 57 to the reception memory section 55 (step S21). The specification of the decoding start time in this case can be performed by for example writing the decoding start time to a predetermined address of a storage section or outputting a signal to the reception memory section 55. In addition, at this time, the transmission start indicating signal is transmitted from the synchronization controlling section 57 to the camera 31a-1.

Thereafter, a request to start a timer for observing a time up to the decoding start time is made in the reception memory section 55 (step S22).

Further, the image data received from the camera 31a-1 via the communicating section 54 is sequentially transferred to the reception memory section 55 (step S23). The image data transferred in this step is stored until the decoding start time.

Then, when the decoding start time specified in step S21 has arrived (step S24), whether the reception of the image data to be transmitted and received is completed at the time point is determined (step S25). When the image data to be transmitted and received cannot be detected in this step, the process returns to step S21 to make readjustment of the timing of transmission and reception of the image data.

When the image data to be transmitted and received is detected in step S25, on the other hand, a process of decoding the image data in decoding units is performed (step S26).

The process of decoding the image data in decoding units is repeated until the processing of all lines within a picture is completed (step S27). The receiving process is ended at a point in time when the processing of all the lines is completed.

An outline of the operation of achieving synchronization between the studio 22a and the sub 23a as a part of the first embodiment of the present invention has been described thus far with reference to FIGS. 5 to 8. In the present embodiment, the CCU 33a has the synchronization controlling section 57 for transmitting a signal specifying an image data transmission start time to the cameras 31a-1 and 31a-2.

According to such a configuration, in a case where there are a plurality of transmitting devices for a receiving device, when a plurality of pieces of image data are managed or integrated on the receiving side, the CCU 33a can function as a timing controller, and achieve synchronization between the pieces of image data.

In addition, the synchronization controlling section 57 specifies the decoding start time with a time interval for accommodating variations in the communication environment between the decoding start time and the above-described transmission start time for a decoding start indicating section within the reception memory section 55. Then, the decoding start indicating section within the reception memory section 55 determines a decoding start time point on the basis of the specified decoding start time, and gives an instruction to start decoding the image data in decoding units. Thus, the image data transmitted with synchronization achieved between the transmitting devices can be decoded stably in a synchronized state while effects of variations in the communication environment and the like are accommodated.

For example, for the CCU 33a to achieve synchronization between the cameras 31a-1 and 31a-2, a frame synchronization time stamp inserted by the synchronization controlling section 57 is used in communication data transmitted and received between the CCU 33a and the cameras 31a-1 and 31a-2.

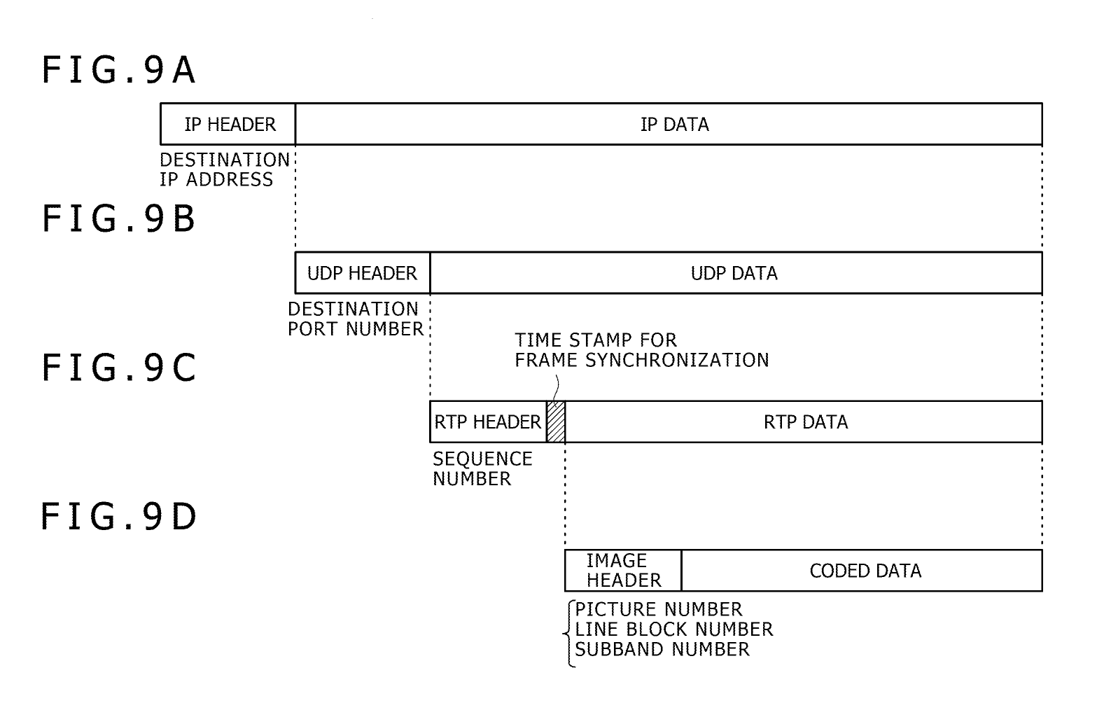

Referring to FIG. 9, description will be made of the frame format of an IP packet as an example of communication data that can be transmitted and received between the CCU 33a and the camera 31a-2.

FIG. 9 shows an internal configuration of one IP packet in four divided stages A to D. Referring to A in FIG. 9, the IP packet includes an IP header and IP data. The IP header includes control information relating to control of a communication path on the basis of an IP protocol, such as a destination IP address and the like.

The IP data further includes a UDP header and UDP data (B in FIG. 9). UDP is a protocol of a transport layer of an OSI reference model, which protocol is commonly used at a time of distribution of moving images or audio data whose real-time characteristic is regarded as important, for example. The UDP header includes for example a destination port number as application identifying information.

The UDP data further includes an RTP header and RTP data (C in FIG. 9). The RTP header includes control information for ensuring the real-time characteristic of a data stream, such as a sequence number and the like. In addition, this control information includes a frame synchronization time stamp generated by the synchronization controlling section 57 to achieve synchronization between a plurality of cameras.

In the present embodiment, the RTP data includes a header of image data (which header will hereinafter be referred to as an image header) and coded data as an image body compressed on the basis of the line-based codec (D in FIG. 9). The image header can include for example a picture number, a line block number (line number in a case where coding is performed in units of one line), a subband number, and the like. Incidentally, the image header may be further divided into a picture header given to each picture and a line block header given to each line block.

By thus including the frame synchronization time stamp generated by the synchronization controlling section 57 in an IP packet, one CCU can synchronize a plurality of cameras with each other.

In a communication system including a plurality of CCUs and a plurality of cameras, that is, in the communication system 20 including the CCUs 33a to 33c and the cameras 31a-1 to 31c-3 as shown in FIG. 4, when the CCUs 33a to 33c are not synchronized with each other, the synchronization controlling sections 57 of the respective CCUs 33a to 33c perform processing in different timing. When there is such a difference in synchronization between the CCUs, an image may be disturbed because processing is performed in different timing when a sub is changed.

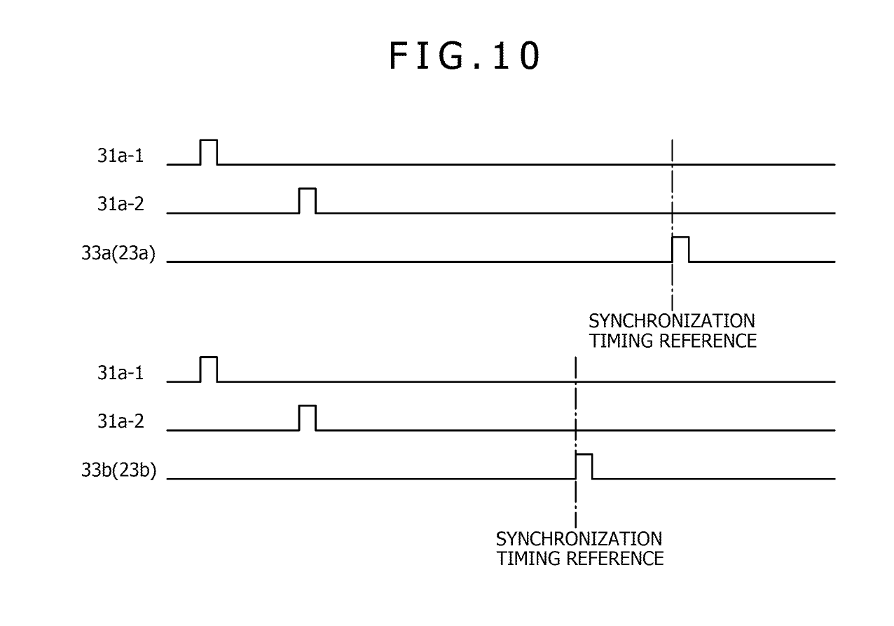

A difference in synchronization between CCUs will be described with reference to FIG. 10, for example.

FIG. 10 shows a difference in synchronization between the CCU 33a and the CCU 33b with the cameras 31a-1 and 31a-2 of the studio 22a as a reference.

As shown in FIG. 10, when there is a difference in synchronization between the CCU 33a and the CCU 33b, and video data is changed from the sub 23a to the 23b, the images are not synchronized with each other. Thus, after the cameras 31a-1 and 31a-2 are operated with the sub 23a as a reference, and the change is made to the sub 23b, the cameras 31a-1 and 31a-2 need to be synchronized again with the sub 23b as a reference. Therefore, in a video system that frequently performs switching between the sub 23a and the sub 23b, video is disturbed frequently, and is thus not suitable for use in live relay broadcasting.

Accordingly, as shown in FIG. 4, the delay controlling device 24 is introduced into the communication system 20. The delay controlling device 24 performs arbitration between the sub 23a and the sub 23b, and determines master timing. Incidentally, the delay controlling device 24 may be not only configured as a device connected to the circuit switching device 21 but also implemented in the subs 23a to 23c.

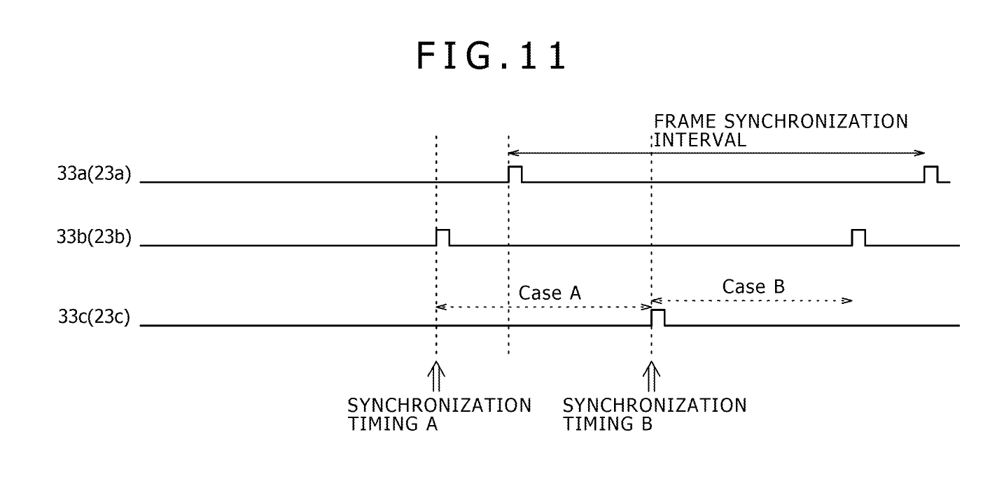

An outline of operation of the delay controlling device 24 will be described with reference to FIG. 11. FIG. 11 represents an example of a process of determining master timing in the three subs 23a to 23c.

In an environment having three different frame synchronization timings, to set the frame synchronization timing of one sub as master timing, the delay controlling device 24 is provided with a buffer for delaying the video data of the other two subs, and searches for a sub that minimizes the amounts of delay of the other two subs. Suppose that at this time, an amount of delay due to a network connection from each sub to each studio is a negligible level. That is, suppose that as in the communication system 20 in FIG. 4, the subs 23a to 23c are once connected to the circuit switching device 21, and connected from the circuit switching device 21 to the studios 22a to 22c. Because distances from the subs 23a to 23c to the studios 22a to 22c are constant, the master timing can be determined from only the frame synchronization timings of the CCUs 33a to 33c possessed by the subs 23a to 23c.

For example, the delay controlling device 24 first compares the sub 23a and the sub 23b with each other, and detects the sub that can reduce an amount of delay buffer of the other sub more. In the example of FIG. 11, the sub 23b can reduce the amount of delay of the other sub more than the sub 23a.

The delay controlling device 24 next compares the sub 23b and the sub 23c with each other. For the sub 23c, a delay time with respect to the sub 23b is Case A or Case B. The delay controlling device 24 accordingly compares the time intervals of Case A and Case B with each other, determines that the time interval of Case A is shorter, and determines that the sub 23b is a master. In the example of FIG. 11, synchronization timing A is set as master timing. Thus, the sub 23a prepares a buffer so as to be able to provide a delay from the synchronization timing A to the frame synchronization timing of the sub 23a, and the sub 23c prepares a buffer so as to be able to provide a delay from the synchronization timing A to the frame synchronization timing of the sub 23c.

Because the frame synchronization timing of the sub 23b is thus set as master timing, the sub 23a and the sub 23c make the buffers (for example the reception memory section 55 of the CCU 33a in FIG. 6 is used as a buffer) delay by only the differences from the frame synchronization timing of the sub 23b.

Next, FIG. 12 is a block diagram showing an example of configuration of the delay controlling device 24.

As shown in FIG. 12, the delay controlling device 24 includes a switch section 61, a physical layer Rx 62, a physical layer controlling section 63, a received data analyzing section 64, a system synchronization timing adjusting section 65, an image pickup timing managing table 66, an image pickup timing adjustment managing section 67, a synchronization control information transmitting section 68, a transmission data generating section 69, and a physical layer Tx 70.

The switch section 61 has a function of switching between transmission and reception of data. The switch section 61 is connected to a circuit to the circuit switching device 21 (FIG. 4).

The physical layer Rx 62 is a physical layer receiving section for receiving a packet from the circuit. The physical layer Rx 62 receives a packet from a digital network circuit such as Ethernet (registered trademark), an NGN or the like or a wireless circuit. For example, the physical layer Rx 62 starts operating on the basis of a request of the physical layer controlling section 63, and supplies a received packet to the received data analyzing section 64.

The physical layer controlling section 63 detects the received packet, and starts a receiving operation. In addition, the physical layer controlling section 63 controls the physical layer on the basis of control from the transmission data generating section 69.

The received data analyzing section 64 analyzes the type of the received packet, and for example determines that the packet describing the frame synchronization timing of the subs 23a to 23c is received.

The system synchronization timing adjusting section 65 adjusts synchronization timing while exchanging information with the image pickup timing managing table 66 on the basis of the packet analyzed by the received data analyzing section 64. That is, the system synchronization timing adjusting section 65 determines the master timing as described with reference to FIG. 11.

The image pickup timing managing table 66 manages (stores) the frame synchronization timing of the subs 23a to 23c and amounts of delay from the subs 23a to 23c to the cameras 31a-1 to 31c-3 of the studios 22a to 22c from the system synchronization timing adjusting section 65. When determining the master timing, the system synchronization timing adjusting section 65 refers to the frame synchronization timing of the subs 23a to 23c and the amounts of delay from the subs 23a to 23c to the cameras 31a-1 to 31c-3 of the studios 22a to 22c.

The image pickup timing adjustment managing section 67 manages the transmission of frame synchronization information to the cameras 31a-1 to 31c-3 of the studios 22a to 22c so that video data can be received in the master timing determined by the system synchronization timing adjusting section 65.

The synchronization control information transmitting section 68 controls the transmission of the synchronization information on the basis of the start timing received from the image pickup timing adjustment managing section 67.

The transmission data generating section 69 generates each packet adapted to the circuit of the physical layer Tx 70.

The physical layer Tx 70 is a physical layer transmitting section for transmitting a packet to the circuit. The physical layer Tx 70 transmits a packet from a digital circuit such as Ethernet (registered trademark), an NGN or the like or a wireless circuit. For example, the physical layer Tx 70 starts operating on the basis of a request of the physical layer controlling section 63, and outputs a communication packet supplied from the transmission data generating section 69 to the switch section 61.

It is to be noted that while the present embodiment is configured such that the delay controlling device 24 described with reference to FIG. 12 determines the time intervals of Case A and Case B shown in FIG. 11, the present embodiment is not limited to such a configuration. After the delay controlling device 24 obtains Case A and Case B, it is possible for example to display Case A and Case B as delay information on the display section 34a of the sub 23a, and allow a user viewing the delay information to select Case A or Case B by operating the operating section 35a.

In addition, the delay controlling device 24 can be configured to include a buffer for delaying data for the subs 23a to 23c to coincide with the master timing (for example have a buffer between the physical layer Rx 62 and the physical layer Tx 70), and transmit the data delayed until predetermined timing to the network of the communication system 20. In addition to such a configuration, another configuration may be adopted in which the CCUs 33a to 33c have a delay buffer and control an amount of delay by receiving amount of delay indicating information from the delay controlling device 24.

Incidentally, in common with the present embodiment, when the above-described line-based wavelet transform is used as line-based codec, communication packets can be generated in subband units of line blocks rather than line block units. In that case, a storage area corresponding to a line block number and a subband number obtained from an image header, for example, may be secured in the reception memory section, and image data resolved into frequency components may be stored in subband units of line blocks.

At this time, when a subband (or a part of the subband) is missing due to a transmission error or the like while decoding is performed in line block units, for example, dummy data may be inserted in subbands subsequent to the missing subband within a line block, and normal decoding may be performed from a next line block.

### Second Embodiment

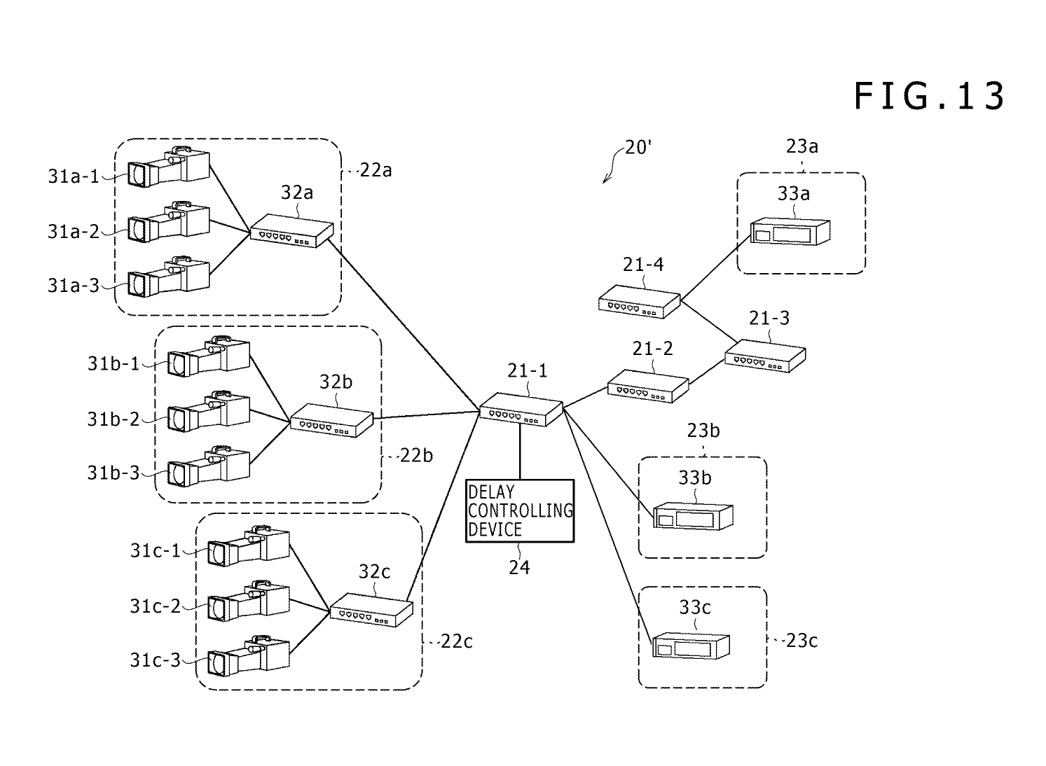

FIG. 13 is a block diagram showing an example of configuration of a second embodiment of the communication system to which the present invention is applied.

The foregoing first embodiment has been described assuming that differences in amount of delay due to network connections from the subs 23a to 23c to the studios 22a to 22c are a negligible level. In practice, however, when connection paths differ greatly from each other, synchronization needs to be achieved with the differences in amount of delay taken into account. Accordingly, in the second embodiment, description will be made of a configuration such that connection paths between the studios 22a to 22c and the subs 23a to 23c differ from each other.

As shown in FIG. 13, the circuit connection configuration (network topology in the case of Ethernet (registered trademark)) of a communication system 20′ is changed as compared with the communication system 20 of FIG. 4. Specifically, in the communication system 20′, a CCU 33b of a sub 23b and a CCU 33c of a sub 23c are directly connected to a circuit switching device 21-1, whereas a CCU 33a of a sub 23a is connected to the circuit switching device 21-1 via circuit switching devices 21-2 to 21-4.

For the example of configuration of such a communication system 20′, a case where a difference in frame synchronization timing between the sub 23a and the sub 23b is similar to that described with reference to FIG. 4 is assumed, and description will be made centering on differences from the first embodiment.

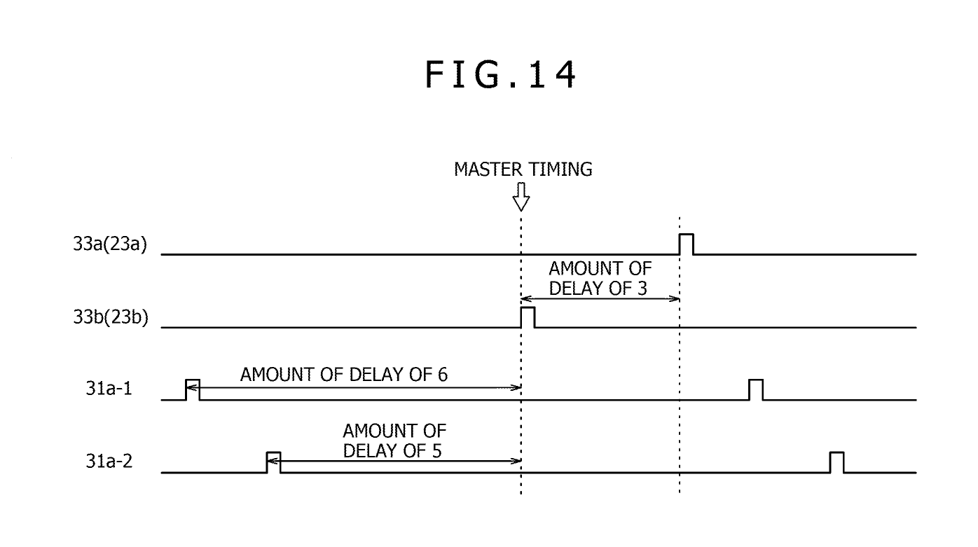

FIG. 14 is a diagram showing system timing after synchronization of cameras 31a-1 and 31a-2 of the studio 22a is obtained in a case where the sub 23b has master timing. That is, in FIG. 14, the frame synchronization timings of the cameras 31a-1 and 31a-2 are generated with the frame synchronization timing of the sub 23b (=master timing) as a reference.

Consideration will first be given to a total amount of delay of the communication system 20′ as a whole in FIG. 14. Suppose that an amount of delay from the master timing to the frame synchronization timing of the camera 31a-1 is 6 (an amount of delay including jitter from the camera 31a-1 to the sub 23b). In this case, the frame synchronization timing of the camera 31a-1 is advanced in phase by a time interval corresponding to a delay time of 6 with respect to the frame synchronization timing of the CCU 33b, and the camera 31a-1 adjusts a time of arrival of a packet at the CCU 33b so that the packet can be handled in the frame synchronization timing of the CCU 33b.

On the other hand, suppose that an amount of delay from the master timing to the frame synchronization timing of the camera 31a-2 is 5 (an amount of delay including jitter from the camera 31a-2 to the CCU 33b). In addition, the CCU 33a of the sub 23a has frame synchronization timing delayed by an amount of delay of 3 with reference to the frame synchronization timing of the CCU 33b of the sub 23b. Thus, a total amount of delay in the communication system 20′ is 14 (the amount of delay of 6+the amount of delay of 5+the amount of delay of 3). Incidentally, units of amounts of delay are not limited in the present specification. In the above, the amounts of delay have been described on the basis of ratios. However, the amounts of delay may be time or in clock units.

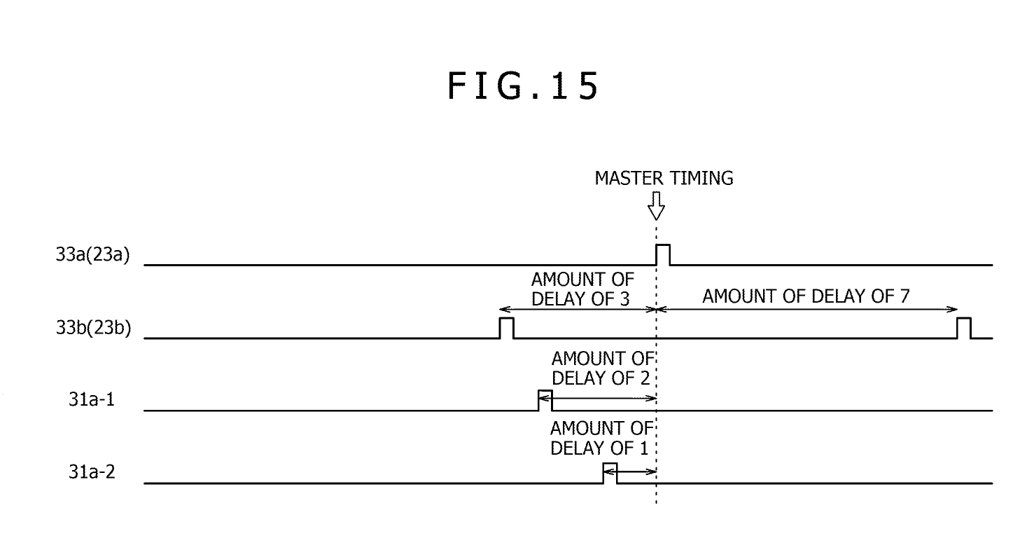

A total amount of delay in the communication system 20′ when the master timing is set in the CCU 33a of the sub 23a in contrast to the case where the sub 23b has the master timing will be described with reference to FIG. 15.

As shown in FIG. 15, when the master timing is set in the CCU 33a of the sub 23a, an amount of delay between the sub 23a and the sub 23b is increased by an amount of delay of 4 (an amount of delay of 7−the amount of delay of 3) as compared with the case where the sub 23b has the master timing (FIG. 14).

However, unlike the communication system 20 of FIG. 4, the circuit connection configuration (network topology in the case of Ethernet (registered trademark)) in the communication system 20′ of FIG. 13 has an amount of delay of 2 from the master timing to the frame synchronization timing of the camera 31a-1 (an amount of delay including jitter from the camera 31a-1 to the sub 23a), and has an amount of delay of 1 from the master timing to the frame synchronization timing of the camera 31a-2 (an amount of delay including jitter from the camera 31a-2 to the sub 23a). Because the frame synchronization timings of the camera 31a-1 and the camera 31a-2 occur cyclically, and a plurality of circuit switching devices are inserted between the circuit switching device 21-1 and the sub 23a, the difference in amount of delay between the communication system 20 of FIG. 4 and the communication system 20′ of FIG. 13 is caused by a difference between the amount of delay from the point of view of the sub 23b and the amount of delay from the point of view of the sub 23a. Thus, a total amount of system delay is 10 (the amount of delay of 7+the amount of delay of 2+the amount of delay of 1), which amount of delay is smaller than in the case where the sub 23b has the master timing (FIG. 14).

By thus determining a device having the master timing (CCU) with an amount of delay from a device having frame synchronization timing (CCU) to a camera also taken into account in determining the master timing, it is possible to reduce the total amount of system delay, and make lower-delay system settings.

It is to be noted that the present embodiment is not limited to the configuration shown in FIG. 13. The communication system 20′ of FIG. 13 is intended for description of an environment in which distances from cameras to subs are different from each other, and the environment is a mere means for making description in a more understandable manner. Suppose that the master timing is determined in consideration of for example differences in amount of delay between connection circuits to cameras within each studio or differences in amount of delay due to devices within each sub as well as differences in amount of delay between circuits between studios. The present invention is also applicable to internal factors in the amounts of delay. In addition, suppose that network jitter does not need to be included.

As described above, the first embodiment has presented the method of performing arbitration of frame synchronization timing between CCUs before calculating delays between cameras and the CCUs and notifying the frame synchronization timing to each camera on the basis of master timing. In addition, the second embodiment has presented the method of not only performing arbitration of frame synchronization timing between the CCUs but also calculating a total amount of system delay by adding amounts of delay between cameras and the CCUs to arbitration parameters in searching for the master timing and selecting the master timing that reduces the amount of system delay.

Description will next be made of a third embodiment in which amounts of delay between cameras and CCUs are notified to a delay controlling device 24 (FIG. 12), and the delay controlling device 24 performs arbitration of these amounts of delay, whereby the reference delay time of a system, the reference delay time being different from the frame synchronization timing of the CCUs, is detected. Incidentally, the third embodiment adjusts synchronization timing externally input to the cameras on the basis of the above-described reference delay time, and determines an optimum reference delay time of the system as a whole.

### Third Embodiment

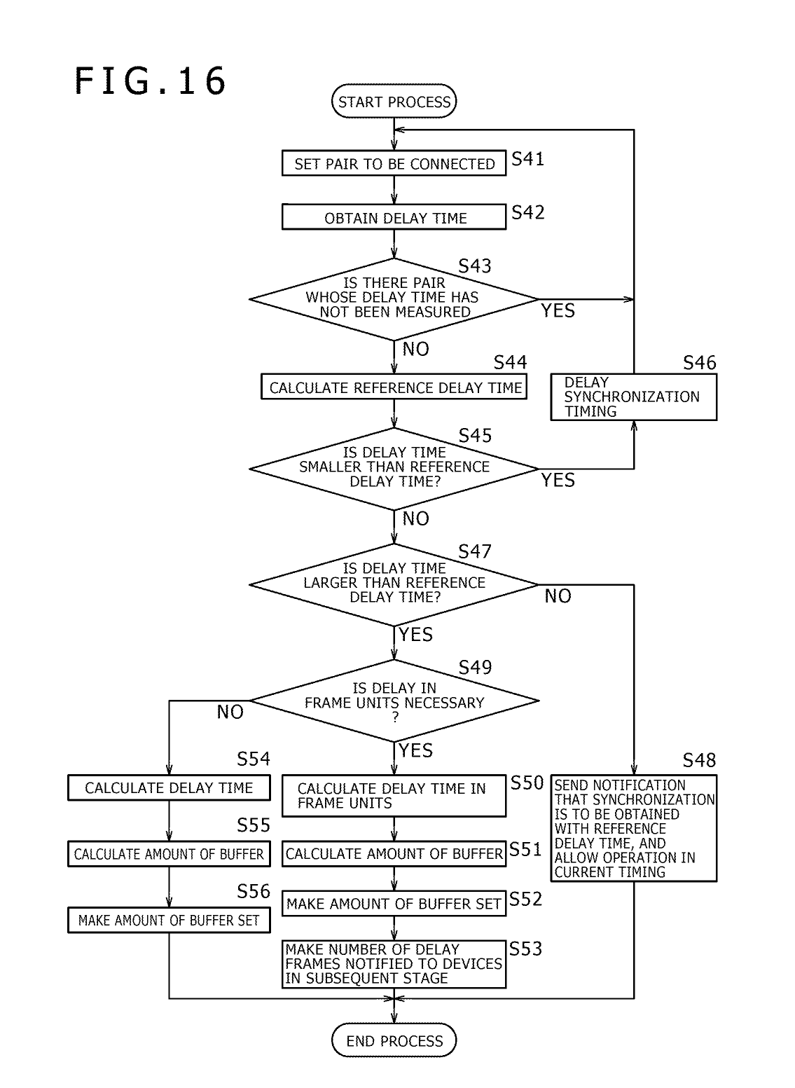

A delay controlling process performed in the third embodiment of the communication system to which the present invention is applied will be described with reference to a flowchart of FIG. 16. Incidentally, this process is performed in a configuration similar to that of the communication system 20 in FIG. 4.

For example, the process is started at a time of starting the communication system 20. In step S41, the delay controlling device 24 sets a combination as a pair to measure a delay time among cameras 31a-1 to 31c-3 and CCUs 33a to 33c. Specifically, the delay controlling device 24 determines a combination of a camera 31 and a CCU 33 as a pair, and notifies the CCU 33 to measure a delay time between the CCU 33 and the camera 31 set as the pair to the CCU 33. At this time, for example, the delay controlling device 24 sets tentative master timing, which is arbitrary timing other than the synchronization timing of the CCUs 33a to 33c, and makes the process performed. Then receiving the notification from the delay controlling device 24, the CCU 33 measures an amount of delay and an amount of network jitter between the CCU 33 and the camera 31 set as the pair, and calculates a delay time.

When the CCU 33 notifies the delay time to the delay controlling device 24, the delay controlling device 24 obtains the delay time notified from the CCU 33 in step S42. The process then proceeds to step S43.

In step S43, the delay controlling device 24 determines whether there is a pair of a camera 31 and a CCU 33 whose delay time has not been measured. When the delay controlling device 24 determines that there is a pair of a camera 31 and a CCU 33 whose delay time has not been measured, the process returns to step S41. That is, delay times between pairs of all the cameras 31 and all the CCUs 33 constituting the communication system 20 are obtained by repeating the process of steps S41 to S43.

When the delay controlling device 24 determines in step S43 that there is no pair of a camera 31 and a CCU 33 whose delay time has not been measured, on the other hand, the process proceeds to step S44. In step S44, the delay controlling device 24 calculates a reference delay time Tb, which is a delay time serving as a reference, on the basis of the delay times between the pairs of all the cameras 31 and all the CCUs 33 which delay times have been obtained in the process of steps S41 to S43.

In step S45, the delay controlling device 24 determines whether the delay time between the camera 31 and the CCU 33 is smaller than the reference delay time Tb.

When the delay controlling device 24 determines in step S45 that the delay time between the camera 31 and the CCU 33 is smaller than the reference delay time Tb, the process proceeds to step S46. In step S46, the delay controlling device 24 notifies the CCU 33 to delay the tentative master timing set tentatively by a time obtained by subtracting a delay time Ts (that is a delay time between the camera 31 and the CCU 33 and which is less than the reference delay time Tb) from the reference delay time Tb. After the process of step S46, the process returns to step S41 to thereafter repeat a similar process.

Specifically, because the delay controlling device 24 calculates a delay managing time (not dependent on the synchronization timing of the CCU 33) (the reference delay time Tb=the delay managing time−the image pickup time of the camera), the delay controlling device 24 notifies the CCU 33 to delay the image pickup time of the camera by a time (the reference delay time Tb−the delay time Ts) with the delay managing time as a reference. This is to enable video data to be handled at the delay managing time even though the delay time Ts is present between the camera 31 and the CCU 33. In step S46, the delay controlling device 24 transmits a command to advance synchronization timing or a command to delay the synchronization timing to each camera 31, and thereby performs control so that video data can be handled with the delay managing time as a reference.

When the delay controlling device 24 determines in step S45 that the delay time between the camera 31 and the CCU 33 is not smaller than the reference delay time Tb (equal to or larger than the reference delay time Tb), on the other hand, the process proceeds to step S47.

In step S47, the delay controlling device 24 determines whether the delay time between the camera 31 and the CCU 33 is larger than the reference delay time Tb.

When the delay controlling device 24 determines in step S47 that the delay time between the camera 31 and the CCU 33 is not larger than the reference delay time Tb, the process proceeds to step S48. That is, in this case, when the determination in step S45 is included, the delay time between the camera 31 and the CCU 33 and the reference delay time Tb are an identical time.

In step S48, the delay controlling device 24 notifies the CCU 33 to obtain synchronization with the reference delay time Tb. Thereby, the CCU 33 that has received the notification makes a setting so as to operate with the reference delay time Tb, that is, continues operation without an amount of video buffer being newly set, and the delay controlling process is ended. At this time, current timing, that is, the tentative master timing set tentatively is set as master timing, and processing is performed with the master timing.

When the delay controlling device 24 determines in step S47 that the delay time between the camera 31 and the CCU 33 is larger than the reference delay time Tb, on the other hand, the process proceeds to step S49.

In step S49, the delay controlling device 24 determines whether the delay time T1 between the camera 31 and the CCU 33 (which delay time T1 is the delay time between the camera 31 and the CCU 33 and which delay time is larger than the reference delay time Tb) is a time that needs a delay in frame units. For example, when the delay time T1 is equal to or more than the time of one frame, the delay controlling device 24 determines that the delay time T1 is a time that needs a delay in frame units, and when the delay time T1 is less than the time of one frame, the delay controlling device 24 determines that the delay time T1 is not a time that needs a delay in frame units.

When the delay controlling device 24 determines in step S49 that the delay time T1 is a time that needs a delay in frame units, the process proceeds to step S50.

In step S50, the delay controlling device 24 calculates a delay time in frame units. For example, the delay controlling device 24 calculates (the reference delay time Tb+the number n of frames×one-frame time Tfr)−the delay time T1 as the delay time in frame units. The number of frames in this case is the number of frames to be delayed.

In step S51, the delay controlling device 24 calculates an amount of buffer necessary to store image data for the delay time on the basis of the delay time in frame units which delay time is calculated in step S50. In step S52, the delay controlling device 24 notifies the amount of buffer calculated in step S51 to the CCU 33 to make the amount of buffer set in the CCU 33. Thereby, the delay of an image arriving at the CCU 33 becomes exactly a delay of n frames with respect to the reference delay time Tb. The number n of delayed frames in this case is determined so as to satisfy the reference delay time Tb+the number n of frames×the one-frame time Tfr>the delay time T1.

Incidentally, the process of calculating and setting the amount of buffer may be performed on the side of the CCU 33. That is, the delay controlling device 24 may notify the delay time in frame units which delay time is calculated in step S50 to the CCU 33, and the CCU 33 may calculate and set the amount of buffer.

In step S53, the delay controlling device 24 notifies the CCU 33 to notify the number n of delayed frames to devices in a stage subsequent to the CCU 33. In response to the notification, the CCU 33 notifies the number n of frames to the devices in the subsequent stage. Then the delay controlling process is ended.

When the delay controlling device 24 determines in step S49 that the delay time T1 is not a time that needs a delay in frame units, on the other hand, the process proceeds to step S54.

In step S54, the delay controlling device 24 calculates a delay time (delay time less than the time of one frame). For example, the delay controlling device 24 calculates (the reference delay time Tb+the one-frame time Tfr)−the delay time T1 as delay time.

Thereafter, in step S55, the delay controlling device 24 calculates an amount of buffer necessary to store image data for the delay time on the basis of the delay time calculated in step S54. In step S56, the delay controlling device 24 notifies the amount of buffer to the CCU 33 to make the amount of buffer set in the CCU 33. Incidentally, the process of calculating and setting the amount of buffer may be performed on the side of the CCU 33. In addition, the amount of buffer corresponding to the delay time is set so as to be reduced as much as possible. The delay controlling process is ended after the process of step S56.

As described above, by detecting the reference delay time of the system, the reference delay time being different from the frame synchronization timing of the CCUs, the third embodiment can adjust synchronization timing externally input to the cameras, and determine an optimum reference delay time of the system as a whole.

For example, in the first and second embodiments, the CCU 33 performs timing management as a master, and thus system timing management can be performed relatively easily, whereas the third embodiment measures an amount of peer-to-peer delay rather than depending on the frame synchronization timing of a certain CCU 33, and can thus make more flexible measurement. Thus, the third embodiment is suitable in processing in an environment in which one of a plurality of CCUs 33 (with different frame synchronization timings) has a prominent delay or in a case where an amount of delay equal to or more than a frame synchronization interval occurs.

In addition, in the third embodiment, letting Tb be the delay time serving as a reference, because of different connection environments between each camera 31 and each CCU 33, there is a case of a smaller delay (delay time Ts) than the reference delay time Tb or a case of a larger delay (delay time T1) than the reference delay time Tb. Accordingly, when the delay between the camera 31 and the CCU 33 is smaller than the reference delay time Tb (delay time Ts), the delay controlling device 24 instructs the intended camera to delay image pickup timing by the time obtained by subtracting the delay time Ts from the reference delay time Tb. Thereby, the delay of video arriving at the CCU 33 is adjusted to be equal to the reference delay time Tb between the camera 31 and the CCU 33.

Incidentally, because the delay controlling device 24 is desired to determine the reference delay time in consideration also of an amount of video buffer corresponding to network jitter grasped by the CCU 33, the number of measurements may be increased until the network jitter is grasped.

In addition, when the delay is larger than the reference delay time Tb (delay time T1), the third embodiment can select two cases as a system. One is a method of adjusting the amount of video buffer of the CCU 33 to a delay corresponding to the time expressed by (the reference delay time Tb+the one-frame time Tfr)−the delay time T1 to construct the system with a minimum amount of delay. The present method is effective in applications in which the amount of delay of the system as a whole is desired to be reduced as much as possible.

In the other case, a delay managing section instructs the CCU 33 to set a video buffer corresponding to a time expressed by (the reference delay time Tb+the number n of frames×the one-frame time Tfr)−the delay time T1 to make an amount of delay a delay in frame units. The CCU 33 makes adjustment so that the delay of arriving video is exactly a delay of n frames with respect to the reference delay time Tb. In this case, the one-frame time Tfr is a one-frame time, and the number n of frames is determined so as to satisfy the reference delay time Tb+the number n of frames×the one-frame time Tfr>the delay time T1. With the present method, in the existing system, picture repetition due to a delay of n frames occurs when switching is performed between the sub 23a and the sub 23b, for example, in FIG. 4. However, the present function provides at least an effect of avoiding picture disturbance due to switching.

Further, providing a function of indicating to a broadcasting device connected in a stage subsequent to each sub 23 that input video data is delayed by n frames enables the device in the subsequent stage to remove the picture repetition.

In addition, while the delay controlling device 24 is used for arbitration, in addition to the configuration in which the delay controlling device 24 is connected to the circuit switching device 21, the delay controlling device 24 may be incorporated into the CCU 33.

Further, for example, in step S45, the reference delay time Tb may be set to a maximum amount of delay between each camera 31 and each certain CCU 33. In addition, as for adjustment of image pickup time of the cameras, when the system as a whole has an absolute time axis (for example a clock), synchronization timing may be specified by time. Incidentally, while only an amount of video buffer is set in the present embodiment, delay adjustment may be made using both a buffer and a PLL phase adjustment.

It is to be noted that while in the present embodiment, description has been made of a communication system including a camera for transmitting image data and a CCU for controlling the camera, the present invention is not limited to such a configuration. The present invention is applicable to a communication system including a transmitting device for transmitting data and a controlling device for controlling the transmitting device, and is applicable to a delay controlling device for controlling delay in the communication system.

As described above, according to the delay controlling devices, the controlling methods, and the communication systems in accordance with the embodiments of the present invention, a live relay broadcasting system can be constructed at low cost by making provisions for a general-purpose circuit such as Ethernet (registered trademark), NGN, radio or the like, which is very inexpensive as compared with a dedicated circuit or a satellite circuit, whereas a camera and a CCU are connected to each other by a composite cable referred to as an optical fiber cable, a triax cable, or a multiple cable in a camera system for performing existing live relay broadcasting.

In addition, because provision can be made for live relay broadcasting control stations with different frame synchronization timings, the system can be extended easily, and appropriate system configurations can be constructed in appropriate places. For example, although in the past relay broadcasting is performed while switching is performed between studios within same broadcasting station facilities, relay broadcasting switching and the like can be performed between studios in different facilities or in live relay broadcasting with remote facilities by timing operation similar to existing timing operation.

Further, because cameras can be genlocked via an asynchronous network, even when simultaneous relay broadcasting is performed with a plurality of relay broadcasting control stations and a plurality of cameras, low-delay and high-quality camera images can be transmitted by using a line-based codec and implementing a synchronization obtaining method suitable for the line-based codec. It is thereby possible to maintain a low delay at a level allowing high-speed switcher processing of real-time images as a core technique of live relay broadcasting.

The first to third embodiments perform a process of obtaining synchronization between the CCUs 33a to 33c and the cameras 31a-1 to 31c-3 using a frame synchronization time stamp included in an IP packet as described with reference to FIG. 9. However, there is a desire to achieve high-precision synchronization while maintaining a low delay at a level allowing high-speed switcher processing of real-time images as a core technique of live relay broadcasting.

### Fourth Embodiment

A fourth embodiment achieves system synchronization by performing two kinds of synchronization obtainment. The fourth embodiment relates to a packet format for enabling for example the obtainment of synchronization performed in a circuit control layer for a circuit such as Ethernet (registered trademark), an NGN or the like (which synchronization will hereinafter be referred to as circuit control layer synchronization) and the obtainment of synchronization in a video control layer in which synchronization is achieved at a video frame or video picture level on the basis of packets loosely synchronized by the circuit control layer (which synchronization will hereinafter be referred to as video control layer synchronization).

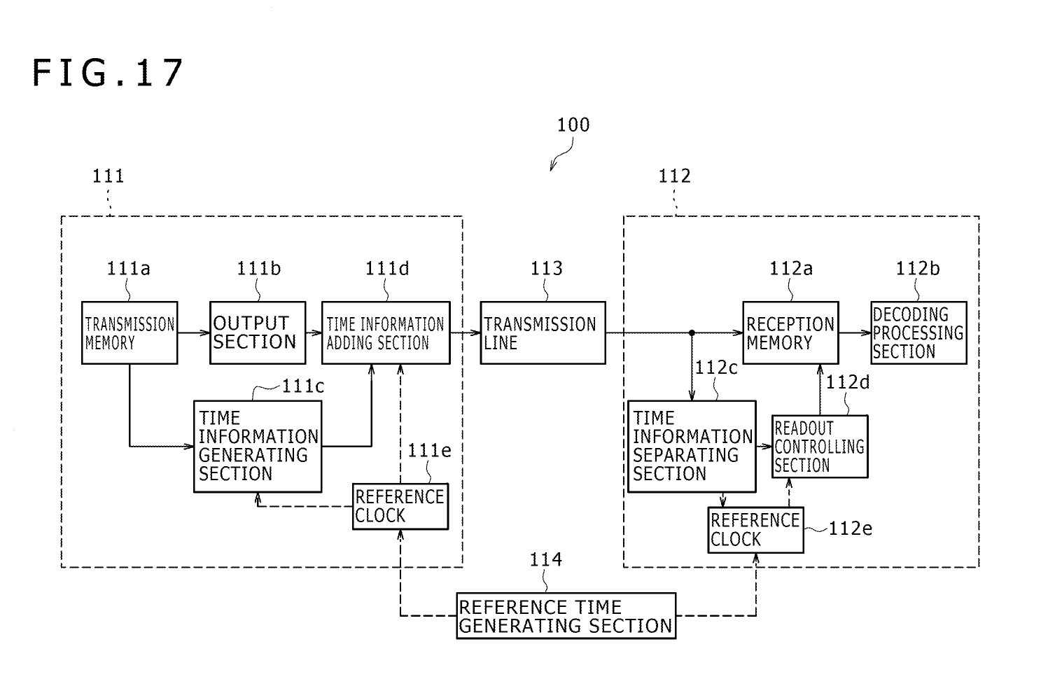

A synchronizing method for video control layer synchronization will first be described with reference to FIG. 17. Incidentally, video control layer synchronization is performed before the delay time described in the first to third embodiments is calculated.

In a data transmission system 100 shown in FIG. 17, a data stream is transmitted from a transmitting device 111 to a receiving device 112. The transmitting device 111 corresponds to the transmitting means of the above-described camera 31. The receiving device 112 corresponds to the receiving means of the above-described CCU 33.

The data transmission system 100 is a system for transmitting a data stream of moving image data, audio data and the like, and reproducing and outputting the data stream in real time. The data transmission system 100 includes the transmitting device 111 for transmitting the data stream, the receiving device 112 for receiving the data stream, and a transmission line 113 (for example the circuit including the circuit switching device 21 described above) through which the data stream is transmitted between these devices.

The transmitting device 111 includes: a transmission memory 111a for temporarily storing a generated data stream; output means 111b for packetizing output data from the transmission memory 111a and outputting the packetized output data to the transmission line 113; time information generating means 111c for generating time information to be transmitted to the receiving device 112; and time information adding means 111d for adding the time information to the output data from the output means 111b.

The receiving device 112 includes: a reception memory 112a for temporarily storing the data stream received via the transmission line 113; decoding processing means 112b for decoding output data from the reception memory 112a; time information separating means 112c for separating the time information added to the received data stream; and readout controlling means 112d for controlling timing of readout of the data stream from the reception memory 112a. Incidentally, the transmitting device 111 and the receiving device 112 may have reference clocks 111e and 112e, respectively, for generating a time serving as a reference for the time information transmitted from the transmitting device 111. In addition, the reference clocks 111e and 112e may generate the time on the basis of reference time information received from reference time generating means 114 provided on the outside.

The transmission line 113 is realized as for example a communication network such as an Ethernet (registered trademark) circuit (including a LAN), an NGN, a wireless LAN or the like.

The transmitting device 111 is supplied with a data stream coded by a predetermined coding system by coding means not shown in FIG. 17. The data stream may be supplied via a storage medium such as a hard disk or the like. The supplied data stream is temporarily stored in the transmission memory 111a, supplied to the output means 111b, and output to the transmission line 113.

In the receiving device 112, the data stream received is temporarily stored in the reception memory 112a and supplied to the decoding processing means 112b to be subjected to decoding processing, and contents of the data stream are output by output means such as a monitor, a speaker and the like not shown in FIG. 17.

In transmission of such a data stream, a transmission delay time until the data stream generated by the coding means is supplied to the decoding processing means 112b in the receiving device 112 is adjusted to be constant to a certain degree, whereby synchronization is achieved between the data input by the coding means and the data output by the decoding processing means 112b.

The data transmission system 100 is configured as described above, so that packetized data is transmitted and received, and circuit control layer synchronization and video control layer synchronization as described above are performed using time stamps included in the packets.

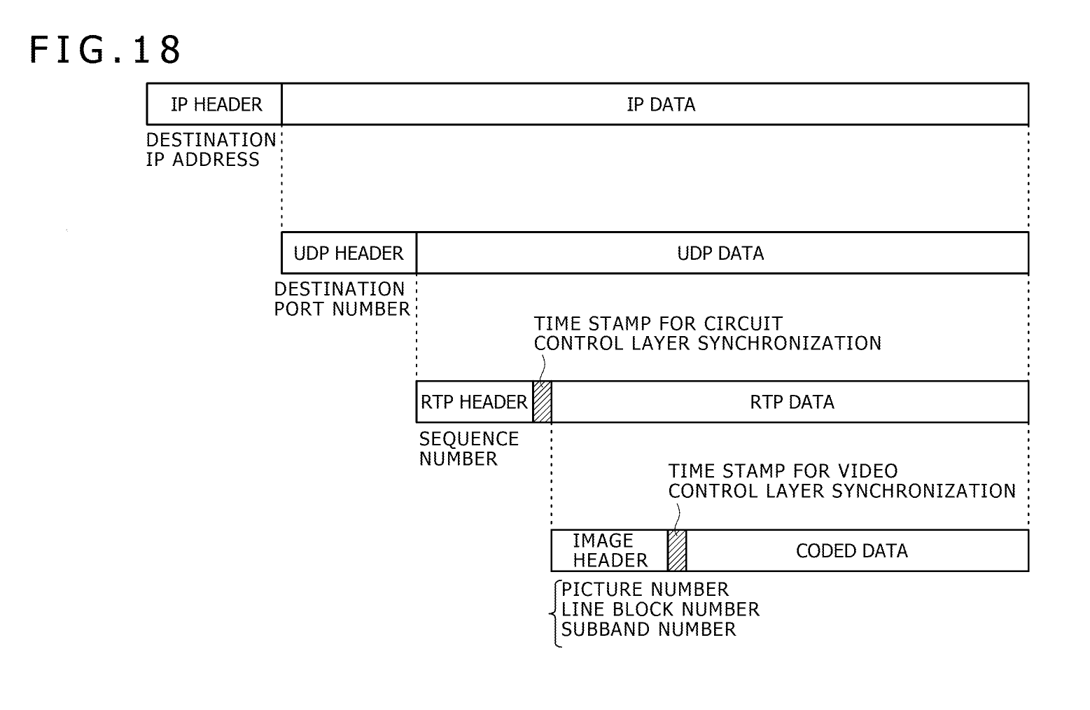

In the following, referring to FIG. 18, description will be made of the frame format of an IP packet as a first example of configuration of a packet used to achieve circuit control layer synchronization and video control layer synchronization in the present embodiment.

As shown in FIG. 18, the IP packet includes an IP header and IP data. The IP header includes control information relating to control of a communication path on the basis of an IP protocol, such as a destination IP address and the like. The IP data further includes a UDP header and UDP data. UDP is a protocol of a transport layer of an OSI reference model, which protocol is commonly used at a time of distribution of moving images or audio data whose real-time characteristic is regarded as important, for example. The UDP header includes for example a destination port number as application identifying information.

The UDP data further includes an RTP header and RTP data. The RTP header includes control information for ensuring the real-time characteristic of a data stream, such as a sequence number and the like. The RTP header includes a time stamp for circuit control layer synchronization.

The RTP data includes an image header and coded data as an image body compressed on the basis of the line-based codec. The image header can include for example a picture number, a line block number (line number in a case where coding is performed in units of one line), a subband number, and the like. The image header includes a time stamp for video control layer synchronization.

The IP packet is thus configured such that the time stamp for circuit control layer synchronization is included in the RTP header and the time stamp for video control layer synchronization is included in the image header. In this case, the time stamp for circuit control layer synchronization and the time stamp for video control layer synchronization do not need to be synchronized with each other.

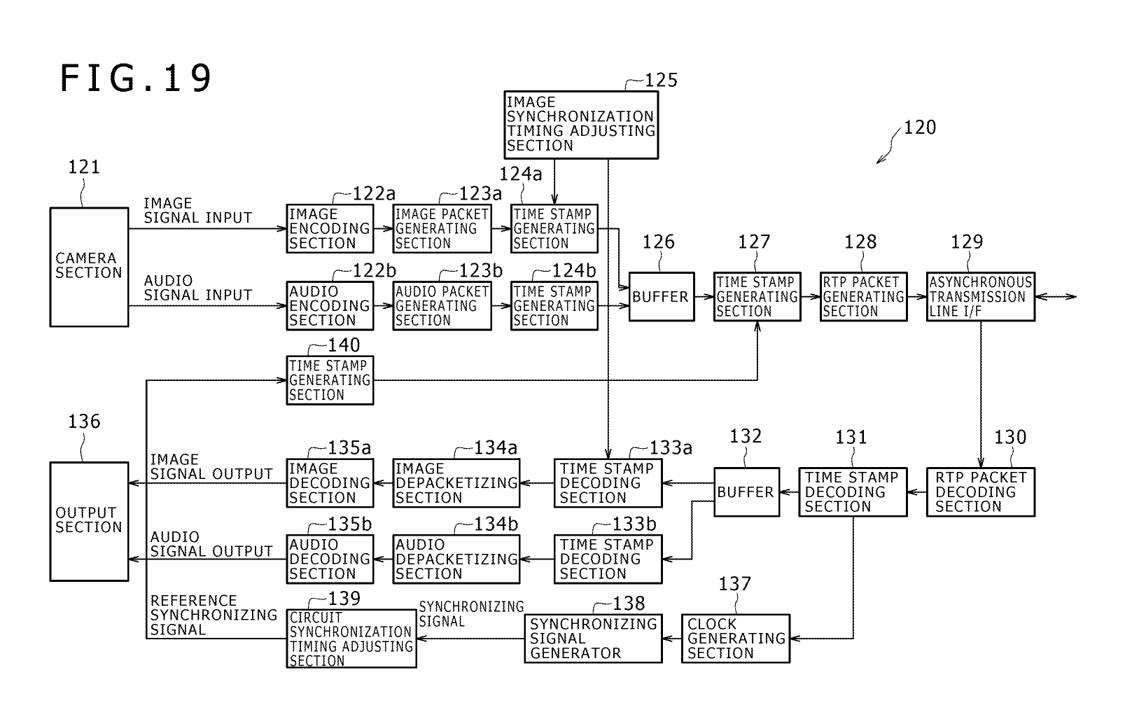

Next, referring to FIG. 19, description will be made of a device for generating and transmitting such an IP packet, and outputting data included in an IP packet transmitted to the device. Whereas the transmitting device 111 and the receiving device 112 are configured as different devices in FIG. 17, description in the following will be made by taking as an example an imaging display device having a transmitting function and a receiving function in FIG. 19.

FIG. 19 is a block diagram showing an example of configuration of an imaging display device to which the present invention is applied.

The imaging display device 120 in FIG. 19 can packetize a signal including a picked-up image and audio and output the packetized signal to an asynchronous transmission line (functions of the studio 22 in FIG. 4), and restore a packetized signal transmitted via the asynchronous transmission line and output the signal (functions of the sub 23 in FIG. 4). Incidentally, the structure of packets generated in the imaging display device 120 will be described with reference to FIG. 19.

The imaging display device 120 includes a camera section 121, an image encoding section 122a, an audio encoding section 122b, an image packet generating section 123a, an audio packet generating section 123b, time stamp generating sections 124a and 124b, an image synchronization timing adjusting section 125, a buffer 126, a time stamp generating section 127, an RTP packet generating section 128, an asynchronous transmission line I/F (interface) 129, an RTP packet decoding section 130, a time stamp decoding section 131, a buffer 132, time stamp decoding sections 133a and 133b, an image depacketizing section 134a, an audio depacketizing section 134b, an image decoding section 135a, an audio decoding section 135b, an output section 136, a clock generating section 137, a synchronizing signal generator 138, a circuit synchronization timing adjusting section 139, and a time stamp generating section 140.

The imaging display device 120 can output a signal including an image and audio obtained by the camera section 121 to the asynchronous transmission line (functions of the studio 22 in FIG. 4), and restore a signal transmitted via the asynchronous transmission line and output the signal to the output section 136 (functions of the sub 23 in FIG. 4).

The camera section 121 includes imaging means such as a CCD or CMOS sensor, audio inputting means such as a microphone, and the like. The camera section 121 obtains an image and audio. An image signal corresponding to the image obtained by the camera section 121 is input to the image encoding section 122a. An audio signal corresponding to the audio obtained by the camera section 121 is input to the audio encoding section 122b.

The image encoding section 122a codes and compresses the image signal, and supplies the coded data to the image packet generating section 123a. The audio encoding section 122b codes and compresses the audio signal, and supplies the coded data to the audio packet generating section 123b.

The image packet generating section 123a packetizes the coded data by converting the coded data of the image signal into the size of one packet and adding an image header to the data. The image packet generating section 123a supplies the packetized coded data of the image signal to the time stamp generating section 124a. Similarly, the audio packet generating section 123b supplies the packetized coded data of the audio signal to the time stamp generating section 124b.

The time stamp generating section 124a adds a time stamp synchronized with media, that is, a time stamp for video control layer synchronization (FIG. 18) to the packetized coded data of the image signal. Similarly, the time stamp generating section 124b adds a time stamp synchronized with the media to the packetized coded data of the audio signal.

The image synchronization timing adjusting section 125 adjusts the timing of the time stamp for video control layer synchronization which time stamp is added by the time stamp generating section 124a. The image synchronization timing adjusting section 125 also adjusts the timing of a time stamp for video control layer synchronization for the time stamp decoding section 133a.

The coded data to which the time stamp is added in the time stamp generating section 124a and the coded data to which the time stamp is added in the time stamp generating section 124b are supplied to the buffer 126, and multiplexed in the buffer 126.

The time stamp generating section 127 adds a time stamp for circuit control layer synchronization (FIG. 18) to the data multiplexed in the buffer 126, and then supplies the data to the RTP packet generating section 128. Incidentally, the time stamp generating section 127 is supplied with a time stamp for circuit control layer synchronization which time stamp is generated in the time stamp generating section 140 referring to a reference synchronizing signal, as will be described later, and the time stamp generating section 127 adds the time stamp for circuit control layer synchronization.

The RTP packet generating section 128 adds an RTP header to RTP data including the coded data and the image header, and supplies the result to the asynchronous transmission line I/F.

The asynchronous transmission line I/F 129 adds a time stamp and an IP header, and then outputs the result to an asynchronous transmission line. For example, when the imaging display device 120 is viewed as a camera 31 in FIG. 4, the asynchronous transmission line I/F 129 transmits the packet to a CCU 33 via the asynchronous transmission line. When the imaging display device 120 is viewed as a CCU 33 in FIG. 4, on the other hand, the asynchronous transmission line I/F 129 receives a packet transmitted from a camera 31 via the asynchronous transmission line.

The RTP packet decoding section 130 is supplied with packets (image data packets, audio data packets, command data packets and the like) received by the asynchronous transmission line I/F 129. The RTP packet decoding section 130 decodes a packet, and supplies the decoded packet to the time stamp decoding section 131.

The time stamp decoding section 131 recognizes an IP header, a UDP header, and an RTP header. RTP data including image data and audio data is supplied to the buffer 132, and a time stamp for circuit control layer synchronization (FIG. 18) added in the rear of the RTP header is supplied to the clock generating section 137.

In the buffer 132, a De-MUM circuit separates the RTP data into a packet of coded data of an image signal and a packet of coded data of an audio signal.

The packet of coded data of the image signal is supplied to the time stamp decoding section 133a, where a time stamp synchronized with the media, that is, a time stamp for video control layer synchronization (FIG. 18) is extracted. The time stamp for video control layer synchronization is used to generate a clock and a synchronizing signal in the output section 136.

The image depacketizing section 134a depacketizes the packet of coded data of the image signal supplied from the time stamp decoding section 133a, and then supplies the coded data of the image signal to the image decoding section 135a. The image decoding section 135a decodes the coded data of the image signal, and then outputs the image signal to the output section 136.

As with the time stamp decoding section 133a, the image depacketizing section 134a, and the image decoding section 135a, the time stamp decoding section 133b, the audio depacketizing section 134b, and the audio decoding section 135b output the audio signal included in the packet of coded data of the audio signal to the output section 136.

The image and audio transmitted via the asynchronous transmission line is thereby output from the output section 136.

In addition, the clock generating section 137 generates a clock of a predetermined frequency, and supplies the clock to the synchronizing signal generator 138. The synchronizing signal generator 138 generates a synchronizing signal from the clock, and supplies the synchronizing signal to the circuit synchronization timing adjusting section 139.

The circuit synchronization timing adjusting section 139 is supplied with the synchronizing signal from the synchronizing signal generator 138, and also supplied with the time stamp for circuit control layer synchronization from the time stamp decoding section 131 via the clock generating section 137 and the synchronizing signal generator 138. The circuit synchronization timing adjusting section 139 adjusts the synchronizing signal on the basis of the time stamp for circuit control layer synchronization, and then outputs a reference synchronizing signal referred to by the time stamp generating section 140 when the time stamp generating section 140 generates a time stamp.

The time stamp generating section 140 refers to the reference synchronizing signal from the circuit synchronization timing adjusting section 139, and generates a time stamp for circuit control layer synchronization to be supplied to the time stamp generating section 127.

In the thus configured imaging display device 120, synchronization in a video control layer (which synchronization will hereinafter be referred to as video control layer synchronization) in which synchronization is achieved at a video frame or video picture level can be obtained on the basis of packets loosely synchronized on the basis of a time stamp for circuit control layer synchronization which time stamp is included in the packets and on the basis of a time stamp for video control layer synchronization. It is thereby possible to achieve high-precision synchronization while maintaining a low delay at a level allowing high-speed switcher processing of real-time images as a core technique of live relay broadcasting.

Incidentally, when the asynchronous transmission line has a sufficiently wide band as compared with a signal, the image encoding section 122a and the audio encoding section 122b are not necessary, and the signal may be subjected to IP packetizing in an uncompressed state as it is. In that case, the image decoding section 135a and the audio decoding section 135b are not necessary either.

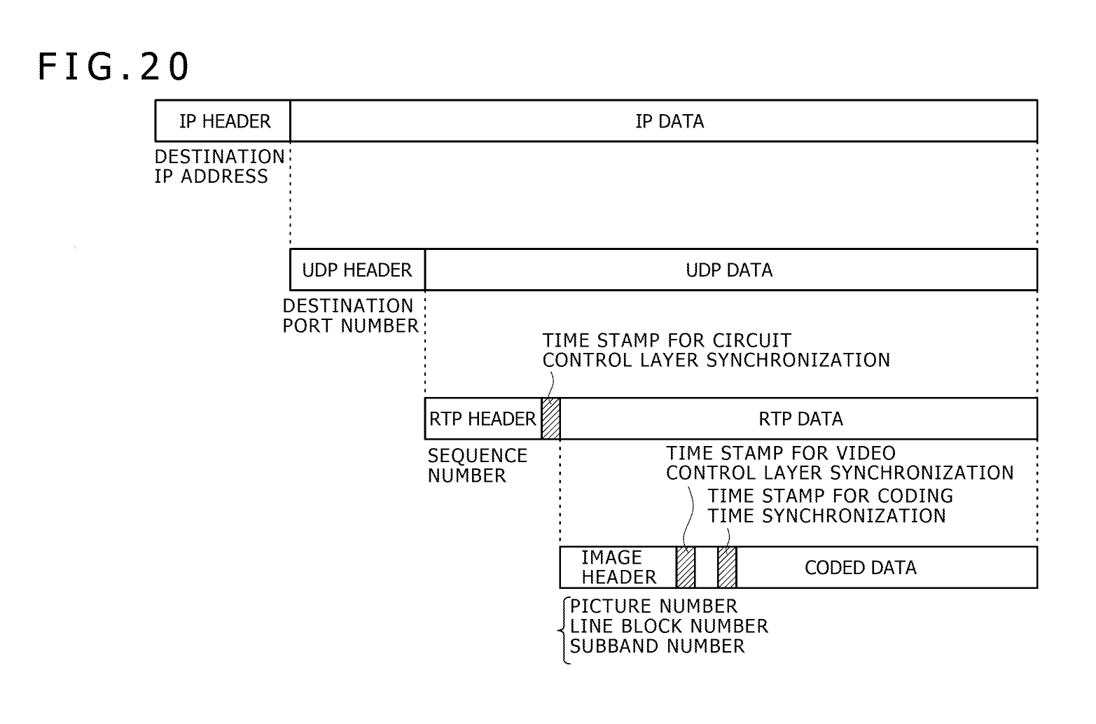

Next, referring to FIG. 20, description will be made of the frame format of an IP packet as a second example of configuration of a packet.

The IP packet shown in FIG. 20 is different from the IP packet shown in FIG. 18 in that a time stamp for coding time synchronization is included in coded data of the IP packet shown in FIG. 20. The IP packet shown in FIG. 20 is otherwise the same as the IP packet shown in FIG. 18. The time stamp for circuit control layer synchronization and the time stamp for video control layer synchronization do not need to be synchronized with each other. The time stamp for video control layer synchronization and the time stamp for coding time synchronization are synchronized with each other.

The addition of not only the time stamp for circuit control layer synchronization and the time stamp for video control layer synchronization but also the time stamp for coding time synchronization to the IP packet as shown in FIG. 20 makes it possible to more accurately set the timing of decoding coded data in the image decoding section 135a and the audio decoding section 135b in FIG. 19, for example, and achieve a lower delay.

Incidentally, when the IP packet as the second example of configuration is used, a time stamp generating section for generating the time stamp for coding time synchronization needs to be provided between the image encoding section 122a and the image packet generating section 123a and between the audio encoding section 122b and the audio packet generating section 123b in the imaging display device 120 of FIG. 9. Further, a decoding section for decoding the time stamp for coding time synchronization needs to be provided between the image depacketizing section 134a and the image decoding section 135a and between the audio depacketizing section 134b and the audio decoding section 135b.

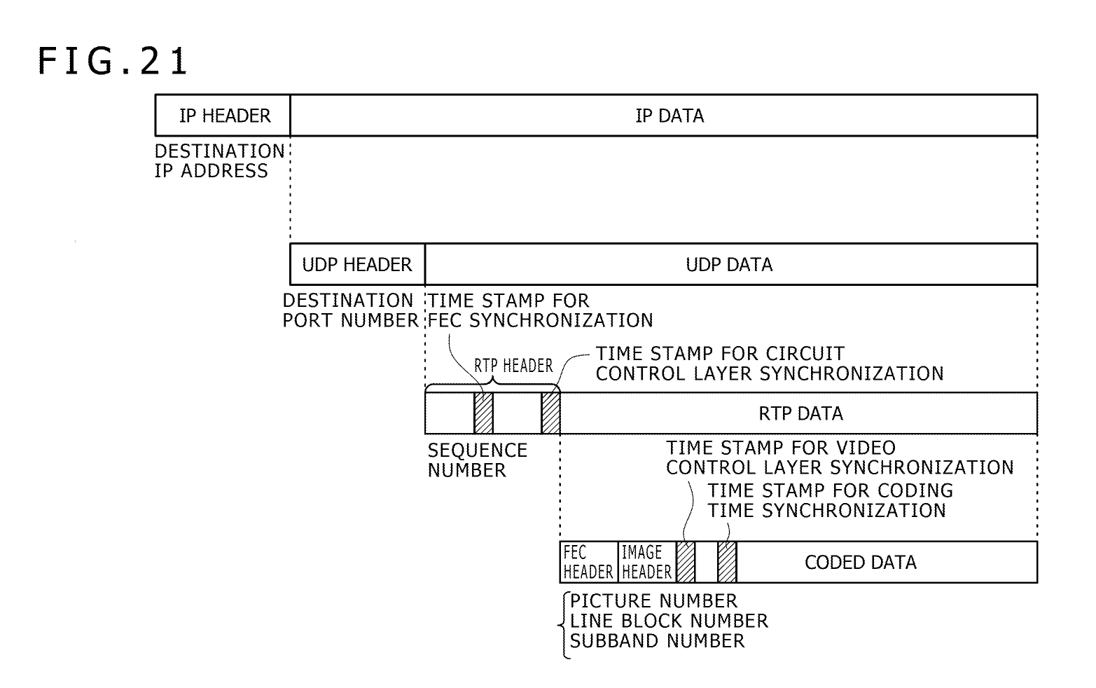

Next, referring to FIG. 21, description will be made of the frame format of an IP packet as a third example of configuration of a packet.

The IP packet shown in FIG. 21 is different from the IP packet shown in FIG. 20 in that the IP packet shown in FIG. 21 has a time stamp for FEC (Forward Error Correction) synchronization which time stamp is included in an RTP header and has an FEC header added to the start of an image header. The IP packet shown in FIG. 21 is otherwise the same as the IP packet shown in FIG. 20. In addition, a time stamp for circuit control layer synchronization and a time stamp for video control layer synchronization do not need to be synchronized with each other. The time stamp for FEC synchronization, the time stamp for video control layer synchronization, and a time stamp for coding time synchronization are synchronized with each other.

The addition of the FEC header and the time stamp for FEC synchronization to the IP packet as shown in FIG. 21 makes it possible to make erasure correction of the packet whose jitter is eliminated by FEC on the basis of the time stamp for FEC synchronization, and achieve an even lower delay.

Incidentally, when the IP packet as a third example of configuration is used, a processing section for performing the processing of erasure correction of the packet whose jitter is eliminated by FEC on the basis of the time stamp for FEC synchronization needs to be provided in a stage subsequent to the buffer 132 in the imaging display device 120 of FIG. 19. In addition, a generating section for generating the FEC header and the time stamp for FEC synchronization needs to be provided. In addition, the IP packet as the third example of configuration is compatible with a standardized RTP packet.

Incidentally, suppose that also in the cases of the IP packets as the second and third examples of configuration, circuit control layer synchronization and video control layer synchronization are performed.

As described above, the fourth embodiment can achieve high-precision synchronization while maintaining a low delay at a level allowing high-speed switcher processing of real-time images as a core technique of live relay broadcasting. That is, with the line-based codec as described above, a time that can be expended for operation is extremely short as compared with a picture-based codec.

In order to solve problems attendant on the extremely short time that can be expended for operation, processing is performed which keeps constant a total time of a standby time of a transmission buffer and a standby time of a reception buffer and which changes a ratio between the standby time of the transmission buffer and the standby time of the reception buffer. For example, when difficult image data is coded, processing is performed which changes the standby times so as to increase the standby time of the buffer used for transmission while decreasing the standby time of the reception buffer. When the standby time of the transmission buffer is thus lengthened, a large amount of transient data generated according to the difficult image can be accommodated in terms of a system delay.

For example, in the existing techniques, because of a picture delay, a buffer for accommodating the jitter of a received packet for a circuit delay is provided, but the circuit delay and the standby time of the reception buffer cannot be separated from each other. Because this separation is impossible, a buffer is required unnecessarily, and a low-delay system is affected.

On the other hand, the present embodiment can separate the circuit delay and the standby time of the reception buffer from each other, and determine the standby time of the reception buffer so as to keep the total time constant according to the standby time of the transmission buffer. Therefore lower-delay synchronization can be achieved. Further, in the present embodiment, by making it possible to change the ratio between the standby time of the transmission buffer and the standby time of the reception buffer at very short time intervals, data of high image quality can be transmitted even with a low delay.

The series of processes described above can be carried out by software as well as by hardware. When the series of processes is to be carried out by software, a program constituting the software is installed from a program recording medium onto a computer incorporated in dedicated hardware or for example a general-purpose personal computer that can perform various functions by installing various programs thereon.

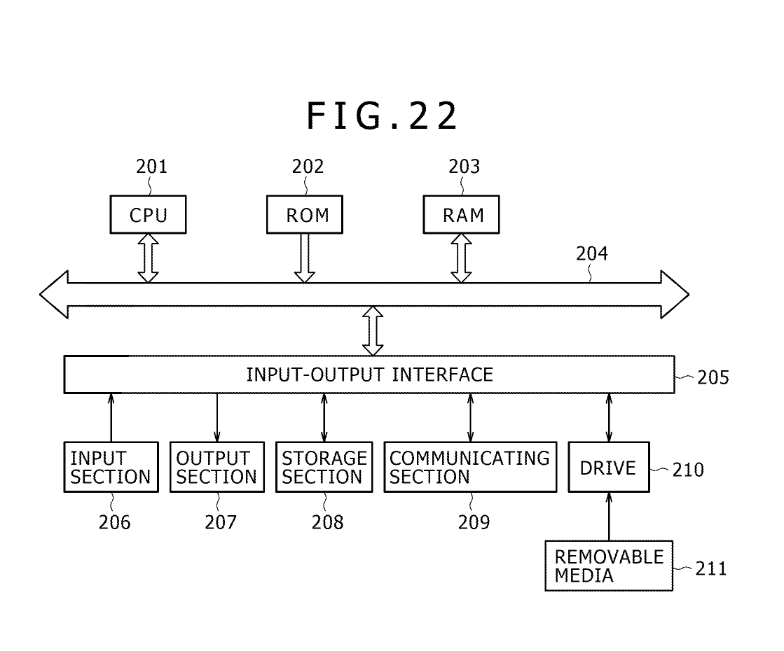

FIG. 22 is a block diagram showing an example of hardware configuration of a computer performing the series of processes described above by a program.

In the computer, a CPU (Central Processing Unit) 201, a ROM (Read Only Memory) 202, and a RAM (Random Access Memory) 203 are interconnected by a bus 204.

The bus 204 is further connected with an input-output interface 205. The input-output interface 205 is connected with an input section 206 formed by a keyboard, a mouse, a microphone and the like, an output section 207 formed by a display, a speaker and the like, a storage section 208 formed by a hard disk, a nonvolatile memory and the like, a communicating section 209 formed by a network interface and the like, and a drive 210 for driving removable media 211 such as a magnetic disk, an optical disk, a magneto-optical disk, a semiconductor memory and the like.

In the computer configured as described above, the CPU 201 for example loads a program stored in the storage section 208 into the RAM 203 via the input-output interface 205 and the bus 204, and then executes the program. Thereby the series of processes described above is performed.

The program executed by the computer (CPU 201) is for example provided in a state of being recorded on the removable media 211 as packaged media including a magnetic disk (including a flexible disk), an optical disk (such as CD-ROM (Compact Disk-Read Only Memory), DVD (Digital Versatile Disk) and the like), a magneto-optical disk, a semiconductor memory and the like, or provided via a wired or wireless transmission medium such as a local area network, the Internet, digital satellite broadcasting or the like.

The program can be installed into the storage section 208 via the input-output interface 205 by loading the removable media 211 into the drive 210. In addition, the program can be received by the communicating section 209 via a wired or wireless transmission medium and installed into the storage section 208. Further, the program can be installed in the ROM 202 or the storage section 208 in advance.

It is to be noted that the program executed by the computer may be a program in which processing is performed in time series in the order described in the present specification or may be a program in which processing is performed in parallel or in necessary timing such as at a time of a call being made, for example.

In addition, in the present specification, a system refers to an apparatus as a whole formed by a plurality of devices.

It is to be noted that embodiments of the present invention are not limited to the foregoing embodiments, and that various changes can be made without departing from the spirit of the present invention.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2010-090962 filed with the Japan Patent Office on Apr. 9, 2010, the entire content of which is hereby incorporated by reference.

What is claimed is:

1. A transmitting device, comprising:
reproduction time information adding means for adding reproduction time information specifying timing of reproduction of data as an object of transmission to said data;
control time information adding means for adding control time information specifying control timing when circuit control is performed on a circuit, said data being to be transmitted through the circuit, to data transfer control information; and
transmitting means for transmitting data to which said reproduction time information and said control time information are added.

2. The transmitting device according to claim 1, further comprising:
coding means for coding said data; and
coding time information adding means for adding coding time information specifying timing of the coding to the coded data coded by said coding means.

3. The transmitting device according to claim 1, further comprising
error control time information adding means for generating control information for error control in data transfer and adding the control information to said data, and adding error control time information specifying timing of error control processing.

4. The transmitting device according to claim 1,
wherein said reproduction time information is disposed in a header for data, the header for data being added to a body part of said data.

5. The transmitting device according to claim 1,
wherein said control time information is disposed in a header for circuit control, the header for circuit control being added to a data part including a body part of said data and a header for data, the header for data being added to the body part of said data.

6. The transmitting device according to claim 2,
wherein said coding time information is disposed in a body part of said data.

7. The transmitting device according to claim 3,
wherein said control information for error control is added to a header for data, the header for data being added to a body part of said data, and said error control time information is disposed in a header for circuit control, the header for circuit control being added to a data part including the body part of said data and the header for data, the header for data being added to the body part of said data.

8. A control method of a transmitting device, the control method comprising the steps of:
adding reproduction time information specifying timing of reproduction of data as an object of transmission to said data;
adding control time information specifying control timing when circuit control is performed on a circuit, said data being to be transmitted through the circuit, to data transfer control information; and
transmitting data to which said reproduction time information and said control time information are added.

9. A receiving device, comprising:
receiving means for receiving transmitted data;
synchronization processing means for extracting control time information specifying control timing when circuit control is performed on a circuit, said data having been transmitted through the circuit, from said data, and performing synchronization processing based on said control time information; and
reproduction processing means for extracting reproduction time information specifying timing of reproduction of said data from said data, and performing reproduction processing in timing based on said reproduction time information.

10. The receiving device according to claim 9,
wherein said data is coded and transmitted, and
the receiving device further comprises decoding means for extracting coding time information specifying timing of coding from the coded data received by the receiving means, and decoding the coded data in timing based on said coding time information.

11. The receiving device according to claim 9, further comprising
error control processing means for extracting error control time information specifying timing of error control processing from said data, and performing the error control processing using control information for error control in data transfer in timing based on said error control time information.

12. The receiving device according to claim 9,
wherein said reproduction time information is disposed in a header for data, the header for data being added to a body part of said data.

13. The receiving device according to claim 9,
wherein said control time information is disposed in a header for circuit control, the header for circuit control being added to a data part including a body part of said data and a header for data, the header for data being added to the body part of said data.

14. The receiving device according to claim 10,
wherein said coding time information is disposed in a body part of said data.

15. The receiving device according to claim 11,
wherein said control information for error control is added to a header for data, the header for data being added to a body part of said data, and said error control time information is disposed in a header for circuit control, the header for circuit control being added to a data part including the body part of said data and the header for data, the header for data being added to the body part of said data.

16. A control method of a receiving device, the control method comprising the steps of:
receiving transmitted data;
extracting control time information specifying control timing when circuit control is performed on a circuit, said data having been transmitted through the circuit, from said data, and performing synchronization processing based on said control time information; and
extracting reproduction time information specifying timing of reproduction of said data from said data, and performing reproduction processing in timing based on said reproduction time information.

17. A communication system, comprising:
reproduction time information adding means for adding reproduction time information specifying timing of reproduction of data as an object of transmission to said data;
control time information adding means for adding control time information specifying control timing when circuit control is performed on a circuit, said data being to be transmitted through the circuit, to data transfer control information;
transmitting means for transmitting data to which said reproduction time information and said control time information are added;
receiving means for receiving the transmitted data;
synchronization processing means for extracting said control time information from said data, and performing synchronization processing based on said control time information; and
reproduction processing means for extracting said reproduction time information from said data, and performing reproduction processing in timing based on said reproduction time information.

18. A control method of a communication system, the control method comprising the steps of:
adding reproduction time information specifying timing of reproduction of data as an object of transmission to said data;
adding control time information specifying control timing when circuit control is performed on a circuit, said data being to be transmitted through the circuit, to data transfer control information;
transmitting data to which said reproduction time information and said control time information are added;
receiving the transmitted data;
extracting said control time information from said data, and performing synchronization processing based on said control time information; and
extracting said reproduction time information from said data, and performing reproduction processing in timing based on said reproduction time information.

19. A transmitting device, comprising:
a reproduction time information adding portion configured to add reproduction time information specifying timing of reproduction of data as an object of transmission to said data;
a control time information adding portion configured to add control time information specifying control timing when circuit control is performed on a circuit, said data being to be transmitted through the circuit, to data transfer control information; and
a transmitting portion configured to transmit data to which said reproduction time information and said control time information are added.

20. A receiving device, comprising:
a receiving portion configured to receive transmitted data;
a synchronization processing portion configured to extract control time information specifying control timing when circuit control is performed on a circuit, said data having been transmitted through the circuit, from said data, and perform synchronization processing based on said control time information; and
a reproduction processing portion configured to extract reproduction time information specifying timing of reproduction of said data from said data, and perform reproduction processing in timing based on said reproduction time information.
